(19) United States
(12) Patent Application Publication
(10) Pub. No.: US 2026/0056560 A1
(43) Pub. Date: Feb. 26, 2026

(54) MULTI-AGENT PATH FINDING WITH REAL ROBOT DYNAMICS AND INTERDEPENDENT TASKS

(71) Applicant: NAVER CORPORATION, Gyeonggi-do (KR)

(72) Inventors: Vassilissa LEHOUX-LEBACQUE, Corenc (FR); Tomi SILANDER, Grenoble (FR); Sofia MICHEL, Saint Ismier (FR); Christelle LOIODICE, La Tronche (FR); Seungjoon LEE, Seoul (FR); Albert WANG, Cambridge, MA (US)

(73) Assignee: NAVER CORPORATION, Gyeonggi-do (KR)

(21) Appl. No.: 19/263,447

(22) Filed: Jul. 8, 2025

Related U.S. Application Data
(60) Provisional application No. 63/687,036, filed on Aug. 26, 2024.

(51) Int. Cl. G05D 1/698; G05D 101/00; G06Q 10/087

(52) U.S. Cl. CPC G05D 1/6987; G06Q 10/087; G05D 2101/22

(57) ABSTRACT

An automated system for a space includes: k navigating robots operating within the space to perform a set of orders, where k is an integer greater than or equal to two, where the space includes one or more waiting areas where any navigating robot may wait without blocking movement of another navigating robot; and a control module configured to receive the set of orders and communicate, to the k navigating robots, paths p for the k navigating robots to fulfil the set of orders, with each order in the set of orders including one or more tasks including a sequence of actions to be performed at a location in the space, having an order availability time after which any task of an order may start, and being associated with a set of precedence constraints arising from at least one of a relationship between orders and a resource of an order.

### CROSS-REFERENCE TO RELATED APPLICATIONS

This application claims the benefit of U.S. Provisional Application No. 63/687,036, filed on Aug. 26, 2024. The entire disclosure of the application referenced above is incorporated herein by reference.

### FIELD

The present disclosure relates to navigating robots and more particularly to systems and methods for controlling multiple navigating robots in a space.

### BACKGROUND

The background description provided here is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Navigating robots are mobile robots that navigate environments without colliding with objects during travel.

Navigating robots may be used in various different industries. One example of a navigating robot is a package handler robot that navigates an indoor space (e.g., a warehouse) to move one or more packages to a destination location. Another example of a navigating robot is an autonomous vehicle that navigates an outdoor space (e.g., roadways) to move one or more occupants from a pickup to a destination.

### SUMMARY

In a feature, an automated system for a space includes: k navigating robots operating within the space to perform a set of orders, where k is an integer greater than or equal to two, where the space includes one or more waiting areas where any navigating robot may wait without blocking movement of any other navigating robot; and a control module configured to receive the set of orders and communicate, to the k navigating robots, paths p for the k navigating robots to fulfil the set of orders, with each order in the set of orders (I) including one or more tasks including a sequence of actions to be performed at a location in the space, (II) having an order availability time after which any task of an order may start, and (III) being associated with a set of precedence constraints arising from at least one of (i) a relationship between orders and (ii) a resource of an order; wherein movements communicated by the control module to the k navigating robots are determined for each order in the set of orders by: (A) sorting the set of orders as function of the set of precedence constraints; (B) assigning resources to complete each task of each order in the set of orders following the sequence of actions associated with the corresponding task; (C) sorting the set of tasks of each order in the set of orders; (D) assigning one of the k navigating robots to each task of each order in the set of orders; (E) for each task t of each order in the set of orders and its assigned navigating robot r, while respecting the order of the sorted orders and the sorted tasks: (i) computing an earliest start time for that task t based on the task t and the location of the navigating robot r in the space; (ii) if the earliest start time of the task t is greater than the completion time of the last action performed by that navigating robot r: (1) finding and reserving a path for the navigating robot r to move to one of the waiting areas, (2) computing a waiting time for the navigating robot r to wait at the waiting area to start the task t while respecting the order availability time and the precedence constraints, and (3) assigning the navigating robot r a waiting time greater than or equal to the waiting time; (iii) while accounting for previous reserved paths, determining a path p starting from the navigating robot r's current location, continuing along the path p to a sequence of locations associated with the task t's sequence of actions, and finishing the path p at the navigating robot r's (a) waiting area or (b) a last location of the last action in the sequence of actions, where waiting times associated with the path p accounting for the navigating robot r's travel time and action performance time; and (iv) reserving the determined path p for performing task t associated with its corresponding order.

In further features, the k navigating robots are configured to move along respective ones of the paths p assigned to those ones of the k navigating robots.

In further features, the precedence constraint is defined by one or more actions of the first order being finished at least a predetermined period of zero or more seconds before the one or more actions of the second order can start.

In further features, a precedence constraint is based on the use of a same resource for multiple different orders.

In further features, the same resource is a same workstation.

In further features, the resource is available for less than all time periods.

In further features, a precedence constraint is based on a first task of a first type that cannot start before a second task of a second time is finished.

In further features, the control module is configured to assign a resource to an action of an order, the resource including one or more of a robot and a workstation.

In further features, the control module is further configured to reserve a path p between a starting location of one of the navigating robots r and the waiting area of the navigating robot r.

In further features, the control module is configured to determine the path p such that the navigating robot r performs the corresponding action for a time at least equal to the action's duration without the navigating robot r colliding with reserved paths of other ones of the navigating robots.

In further features, the navigating robot r not colliding with reserved paths of other ones of the navigating robots is checked by verifying that a bounding box of the navigating robot r does not collide with reserved paths of other ones of the navigating robots.

In further features, the bounding box is greater than a bounding box based on actual dimensions of the navigating robot r.

In further features, the control module is configured to determine the earliest start time of the task k based on (a) completion times of tasks with paths reserved, (b) the task t's corresponding order start time, and (c) the set of precedence constraints.

In further features, the control module is configured to determine a path p for the navigating robot r to one of the waiting areas based on previous reserved paths of other robots.

In further features, one waiting area is assigned per navigating robot.

In further features, the control module is configured to assign one waiting area to multiple ones of the k navigating robots.

In further features, a total number of the one or more waiting areas is one of greater than k and less than k.

In further features, a resource can be used by a predetermined maximum number of actions at a given time and a next action of the resource can start no earlier than the minimum end time of an action using the resource.

In further features, the control module is further configured to reserve one or more paths for one or more moving obstacles.

In further features, the control module is configured to: receive a first graph representing a geometry of the space; determine a second graph using the first graph; and determine the paths for the k navigating robots in the second graph.

In further features, the second graph includes more nodes and more arcs than the first graph to represent a turn in a given direction.

In further features, the second graph includes, for one or more nodes in the first graph, two nodes: a first one for leaving from that node and a second one for going to that node.

In further features, the second graph includes one or more short cut arcs bypassing nodes of a straight line.

In further features, the second graph includes one or more short cut arcs bypassing nodes of a path in the graph.

In further features, the control module is configured to determine the paths based on the second graph and dynamics of the k navigating robots.

In further features, the collection control module is configured to determine the paths further based on the geometry of the k navigating robots.

In further features, the control module is configured to determine the paths further determined based on orientations for the actions, respectively.

In further features, the control module is configured to determine the paths further determined based on orientations for the waiting areas.

In further features, the control module is configured to determine the paths further based on maximum speeds of the navigating robots along arcs of the second graph or at nodes of the second graph.

In further features, the control module is configured to determine the paths further based on time-dependent maximum speeds of the k navigating robots along at least one of (a) arcs of the second graph and (b) at nodes of the second graph.

In further features, the control module is configured to determine the paths of the navigating robots further based on the navigating robots not coming within a predetermined distance of any of the other ones of the k navigating robots while traveling along their respective paths.

In further features, the control module is configured to determine the paths of the k navigating robots further based on constructing incrementally partial paths adding elements at the end of previously computed paths.

In further features, the control module is configured to determine the paths based on comparisons of the partial paths.

In further features, the control module is configured to compare the partial paths further based on heap scores of partial paths using a heap score function including a weighted sum of a penalty.

In further features, the heap score function further includes a weighted sum of a lower bound of durations of a shortest path from the partial path's end to destination passing by all the unreached locations of the sequence of locations and staying at each location for at least the waiting time.

In further features, the penalty is based on a number of remaining unreached locations of the sequence of locations and staying at each location for at least the minimum required time.

In further features, the penalty is based on preventing collisions between ones of the k navigating robots.

In further features, the preventing collisions is based on at least one of (a) dynamics of the k navigating robots and (b) geometry of the k navigating robots.

In further features, the control module is configured to compare ones of the partial paths based on one or more criteria values for the partial paths, the criteria being sorted in a hierarchical order.

In further features, the control module is further configured to compare criterion values of one or more of the criteria based on at least one of (a) criterion values being within the same predetermined value interval and (b) criterion values' difference being below a threshold.

In further features, a first one of the criteria in the hierarchical order is earliest finishing time.

In further features, the criteria include at least two secondary criteria, and a one of the second criteria in the hierarchical order is minimum time in movement.

In further features, the space is one of a physical space and a virtual space.

In further features, the control module is configured to: reserve, in a reservation table, locations in the space at times for the previously planned paths of other ones of the k navigating robots; and determine a feasible path for robot r at E.iii based on avoiding the locations at the times.

In further features, the control module is configured to: reserve, in a reservation table, locations in the space for periods for the previously planned paths of other ones of the k navigating robots; and determine a feasible path for robot r at E.iii based on avoiding the locations during the periods.

In further features, the control module is configured to: reserve, in a reservation table, areas in the space for times for the previously planned paths of other ones of the k navigating robots; and determine a path for robot r at E.iii based on avoiding the areas at the times.

In further features, the collection control module is configured to: reserve, in a reservation table, areas in the space for periods for the previously planned paths of other ones of the k navigating robots; and determine a feasible path for robot r at E.iii based on avoiding the areas for the periods.

In further features, each task of an order of the set of order has exactly two actions, the first being a pickup action, the second being a delivery action.

In further features, the control module is configured to receive at least a portion of the resource assignment.

In further features, the control module is configured to receive at least a portion of the robot assignment.

In further features, the control module is configured to receive at least a portion of the task order.

In further features, the control module is configured to receive at least a portion of the order of orders.

In further features, the control module is further configured to update the set of precedence constraints at (B).

In a feature, an automated method for a space includes: by k navigating robots, operating within the space to perform a set of orders, where k is an integer greater than or equal to two, where the space includes one or more waiting areas where any navigating robot may wait without blocking movement of any other navigating robot; receiving the set of orders and communicating, to the k navigating robots, paths p for the k navigating robots to fulfil the set of orders, with each order in the set of orders (I) including one or more tasks including a sequence of actions to be performed at a location in the space, (II) having an order availability time after which any task of an order may start, and (III) being associated with a set of precedence constraints arising from at least one of (i) a relationship between orders and (ii) a resource of an order; where movements communicated to the k navigating robots are determined for each order in the set of orders by: (A) sorting the set of orders as function of the set of precedence constraints; (B) assigning resources to complete each task of each order in the set of orders following the sequence of actions associated with the corresponding task; (C) sorting the set of tasks of each order in the set of orders; (D) assigning one of the k navigating robots to each task of each order in the set of orders; (E) for each task t of each order in the set of orders and its assigned navigating robot r, while respecting the order of the sorted orders and the sorted tasks: (i) computing an earliest start time for that task t based on the task t and the location of the navigating robot r in the space; (ii) if the earliest start time of the task t is greater than the completion time of the last action performed by that navigating robot r: (1) finding and reserving a path for the navigating robot r to move to one of the waiting areas, (2) computing a waiting time for the navigating robot r to wait at the waiting area to start the task t while respecting the order availability time and the precedence constraints, and (3) assigning the navigating robot r a waiting time greater than or equal to the waiting time; (iii) while accounting for previous reserved paths, determining a path p starting from the navigating robot r's current location, continuing along the path p to a sequence of locations associated with the task t's sequence of actions, and finishing the path p at the navigating robot r's (a) waiting area or (b) a last location of the last action in the sequence of actions, where waiting times associated with the path p accounting for the navigating robot r's travel time and action performance time; and (iv) reserving the determined path p for performing task t associated with its corresponding order.

In a feature, an automated system for a space includes: k navigating means operating within the space to perform a set of orders, where k is an integer greater than or equal to two, where the space includes one or more waiting areas where any navigating means may wait without blocking movement of any other navigating means; means for receiving the set of orders and communicating, to the k navigating robots, paths p for the k navigating means to fulfil the set of orders, with each order in the set of orders (I) including one or more tasks including a sequence of actions to be performed at a location in the space, (II) having an order availability time after which any task of an order may start, and (III) being associated with a set of precedence constraints arising from at least one of (i) a relationship between orders and (ii) a resource of an order; where movements communicated to the k navigating means are determined for each order in the set of orders by: (A) sorting the set of orders as function of the set of precedence constraints; (B) assigning resources to complete each task of each order in the set of orders following the sequence of actions associated with the corresponding task; (C) sorting the set of tasks of each order in the set of orders; (D) assigning one of the k navigating means to each task of each order in the set of orders; (E) for each task t of each order in the set of orders and its assigned navigating means r, while respecting the order of the sorted orders and the sorted tasks: (i) computing an earliest start time for that task t based on the task t and the location of the navigating means r in the space; (ii) if the earliest start time of the task t is greater than the completion time of the last action performed by that navigating means r: (1) finding and reserving a path for the navigating means r to move to one of the waiting areas, (2) computing a waiting time for the navigating means r to wait at the waiting area to start the task t while respecting the order availability time and the precedence constraints, and (3) assigning the navigating means r a waiting time greater than or equal to the waiting time; (iii) while accounting for previous reserved paths, determining a path p starting from the navigating means r's current location, continuing along the path p to a sequence of locations associated with the task t's sequence of actions, and finishing the path p at the navigating means r's (a) waiting area or (b) a last location of the last action in the sequence of actions, where waiting times associated with the path p accounting for the navigating means r's travel time and action performance time; and (iv) reserving the determined path p for performing task t associated with its corresponding order.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a functional block diagram of an example implementation of a navigating robot;

FIG. 2 is a functional block diagram of an example implementation of a collection control system for an indoor space;

FIG. 3 includes three examples of other arrangements of shelves and workstations;

FIG. 4 includes an example illustration of a portion of a routing graph including nodes and arcs;

FIG. 5 includes pseudo-code for an interleaved path planning (IPP) algorithm used to determine paths to fulfill orders;

FIG. 6 includes pseudo-code for a via point star (VP*) algorithm used to determine via points for the shortest paths;

FIG. 7 includes an illustration of an example collision checking method based on robot positions and dynamics;

FIGS. 8-9 illustrate operation of the IPP algorithm; and

FIG. 10 illustrates preprocessing of a warehouse graph to obtain a routing graph (graph conversion).

In the drawings, reference numbers may be reused to identify similar and/or identical elements.

### DETAILED DESCRIPTION

Robotic navigation may combine the domains of vision and control. Navigation can be described as finding a path between a starting location and a destination location while avoiding collisions. A navigating robot includes a control module configured to move the navigating robot based on input from one or more sensors (e.g., cameras, light detection and ranging (LIDAR), etc.) and/or based on external movement instructions that the robot is to follow.

Multi-Agent Path Finding (MAPF) may be considered an optimization problem underlying the deployment of robots in indoor spaces, such as automated warehouses and factories. When solving this optimization problem by planning robot paths, simplifying environment and/or robot dynamics to a large extent may make any planned path difficult to follow in a real setting without collision.

The present application is applicable to online order delivery in a building (e.g., warehouse), where multiple (e.g., a fleet of) robots bring the products belonging to each order from shelves to workstations for packing and shipment. This involves a stream of inter-dependent pick-up and delivery tasks and the associated MAPF problem includes determining realistic collision-free robot trajectories to fulfill these tasks. The present application involves an extension of a Prioritized Planning (PP) algorithm to deal with the inter-dependent tasks, which may be referred to as Interleaved Prioritized Planning (IPP), and a Via-Point Star (VP*) algorithm to compute an optimal dynamics-compliant robot trajectory to visit a sequence of goal locations while avoiding moving obstacles and collisions. The present application is applicable to pickups from shelves with deliveries at workstations, and pickups at workstations with deliveries at shelves and pickups at shelves with deliveries at shelves. While example tasks are provided, the present application is also applicable to other types of tasks. Tasks include a sequence of actions that are to be carried out at specific locations. The tasks are not limited to carrying, picking up, and dropping off, and include other types of tasks.

As described above, MAPF involves planning a set of collision-free paths for a team of agents (e.g., navigating robots) to reach one, or a sequence of goal locations, while minimizing travel time. Example scenarios where MAPF can be used include but are not limited to automated warehouses, video games, unmanned aerial vehicle (UAV) traffic management, autonomous vehicles, and other scenarios. A simplified setting where the environment is modeled as a 4-neighbor grid where each agent occupies one cell at a time and at each discrete time step can either move to a neighboring cell or wait in place could be considered. Even with this simplification, however, finding an optimal solution for the MAPF problem is difficult and slow.

The present application is applicable to an automated warehouse scenario in which large navigating robots move heavy objects in a spatially constrained workspace. Orders for the navigating robots are received over time and each order may include multiple products that a navigating robot is to pick up at specific shelves and locations and deliver to a workstation. Each workstation can process only one order at a time. This creates a stream of inter-dependent pick-up and delivery tasks. The present application is also applicable to the reverse, from workstation to shelf or from shelf to shelf.

The control described herein is based on multiple different parameters. For example, due to the weight of the navigating robots, accelerating and decelerating to full (or zero) linear and angular speed may take multiple seconds (and meters). Since transported objects are heavy, the speed and acceleration also depend on the load of the robot. When path-finding is planned on a graph, a heavy robot cannot necessarily stop from a full speed to the closest node. Furthermore, a large robot also often occupies multiple graph nodes and edges. Large robots may not have space to bypass each other or even turn in place in narrow aisles. If the robot can pickup and drop-off objects only from one of its one sides, the plan should anticipate the turns so that the robots enter the aisles with the right orientation for pickups and drop-offs. Simplified assumptions on robot dynamics could yield trajectories that can quickly lead to collisions when executed by a realistic robot, but this is provided via the concepts described herein.

The present application involves a MAPF solution that takes the aforementioned characteristics into account. The MAPF approach is based on a Prioritized Planning (PP) algorithm which includes ordering the agents in a certain priority order, then determining the shortest path for each agent, avoiding the trajectories of the previously planned agents (which may be considered moving obstacles). PP is well-suited because the shortest path computation is done for each robot separately and can accommodate kinematic constraints. However, PP itself may not handle the collaboration between robots for the interdependent tasks considered here. An extension of PP called Interleaved Prioritized Planning may be used where the priorities are dynamically assigned throughout the planning process.

A shortest path algorithm (e.g., referred to as VP*) may determine an optimal trajectory for a robot to visit a sequence of via points, while avoiding moving obstacles and satisfying kinematic constraints. The shortest path algorithm may be a goal-directed tree search algorithm that involves a heuristic evaluation of the minimal cost of a sub path to the goal. This evaluation may be performed by computing the optimal robot trajectory when ignoring the collisions. A tailored routing multi-graph and fixing the robots speed profiles may be used to solve a polynomial problem and therefore provide an efficient evaluation heuristic for VP*.

In summary, the present application involves an approach to address the MAPF problem in a realistic and challenging warehouse setting: with constrained space, interdependent tasks and complex real robot dynamics. The present application involves the Interleaved Prioritized Planning algorithm for MAPF with inter-dependent tasks. The Via-Point Star (VP*) algorithm determines the shortest single-robot trajectory, which satisfies the kinematics constraints, to visit a sequence of locations while avoiding moving obstacles.

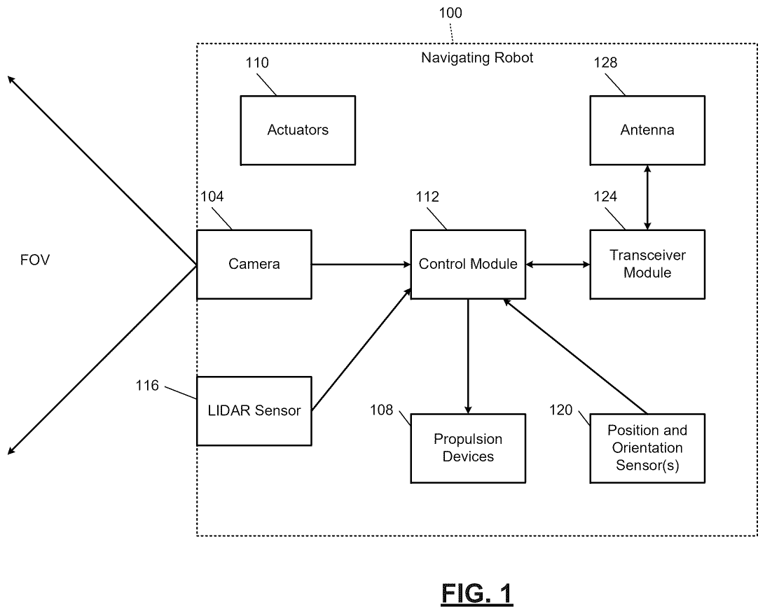

FIG. 1 is a functional block diagram of an example implementation of a navigating robot 100. The navigating robot 100 is one example of an agent, but the present application is also applicable to other types of agents. The navigating robot 100 is a mobile vehicle. The navigating robot 100 may include a camera 104 that captures images within a predetermined field of view (FOV) in front of the navigating robot 100. The operating environment of the navigating robot 100 may be an indoor space or an outdoor space. In various implementations, the navigating robot 100 may include multiple cameras and/or one or more other types of sensing devices (e.g., LIDAR, radar, etc.).

The camera 104 may be, for example, a grayscale camera, a red, green, blue (RGB) camera, or another suitable type of camera. In various implementations, the camera 104 may also capture depth (D) information, such as in the example of a grayscale-D camera or a RGB-D camera. The camera 104 may be fixed to the navigating robot 100 such that the orientation and FOV of the camera 104 relative to the navigating robot 100 remains constant.

The navigating robot 100 includes one or more propulsion devices 108, such as one or more wheels, one or more treads/tracks, one or more moving legs, one or more propellers, and/or one or more other types of devices configured to propel the navigating robot 100 forward, backward, right, left, up, and/or down. One or a combination of two or more of the propulsion devices 108 may be used to propel the navigating robot 100 forward or backward, to turn the navigating robot 100 right, to turn the navigating robot 100 left, and/or to elevate the navigating robot 100 vertically upwardly or downwardly. The navigating robot 100 is configured to transport objects. The navigating robot 100 may include one or more actuators 110 configured to grab, lift, lower, push, and hold objects.

The camera 104 may update (capture an image) at a predetermined frequency, such as 60 hertz (Hz), 120 Hz, or another suitable frequency. The control module 112 may update a labeled map (discussed further below) each time the input from the camera 104 is updated. The navigating robot 100 may also include a light detection and ranging (LIDAR) sensor 116. In various implementations, one of the LIDAR sensor 116 and the camera 104 may be omitted.

The navigating robot may localize itself in space using one or more sensors and to follow a navigation path determined for it as described below.

A control module 112 is configured to control the propulsion devices 108 to navigate a space (e.g., an indoor real world space). The control module 112 may autonomously navigate the space using a map or a representation of the space and/or follow instructions received via the transceiver module 124. The control module 112 controls the propulsion devices 108 to navigate the space according to a path determined for the navigating robot 100 as discussed further below, such as to perform a sequence of localized actions such as collecting items for an order and returning the items to a workspace or other goal location. The control module 112 controls actuation of the actuators 110, such as to grab, pick up, lower, push, hold, and otherwise manipulate the items to be collected and transported by the navigating robot 100 to the workspace or other goal location.

For example, the control module 112 may actuate the propulsion devices 108 to move the navigating robot 100 forward by a predetermined distance under some circumstances. The control module 112 may actuate the propulsion devices 108 to move the navigating robot 100 backward by a predetermined distance under some circumstances. The control module 112 may actuate the propulsion devices 108 to turn the navigating robot 100 to the right by the predetermined angle under some circumstances. The control module 112 may actuate the propulsion devices 108 to turn the navigating robot 100 to the left by the predetermined angle under some circumstances. The control module 112 may not actuate the propulsion devices 108 to not move the navigating robot 100 under some circumstances. The control module 112 may actuate the propulsion devices 108 to move the navigating robot 100 upward under some circumstances. The control module 112 may actuate the propulsion devices 108 to move the navigating robot 100 downward under some circumstances. The control module 112 may actuate the propulsion devices 108 to avoid the navigating robot 100 contacting any objects or walls of the space. In various implementations, the control module 112 may actuate the propulsion devices 108 to move in two or more directions at the same time. The control module 112 may also determine velocity commands, such as linear velocity and/or angular velocity and determine motor speed(s) based on the velocity command(s). In various implementations, the control module 112 may directly determine the motor speed(s).

The navigating robot 100 may include one or more sensors 120 that determine a position (e.g., xy) of the navigating robot 100 within the space and an orientation (e.g., yaw) of the navigating robot 100. Examples of position sensors include triangulation sensors, resolvers, and other types of sensors.

The navigating robot 100 may include one or more transceivers, such as transceiver module 124, that are configured to wirelessly communicate via one or more antennas, such as antenna 128. For example, the navigating robot 100 may transmit one or more of its operating parameters (e.g., position) to a collection control module that controls movement of the navigating robot 100 and one or more other navigating robots within the space.

One example of the navigating robot is the SeRo navigating robot by Naver Corporation, and examples of tasks and orders include moving servers within buildings.

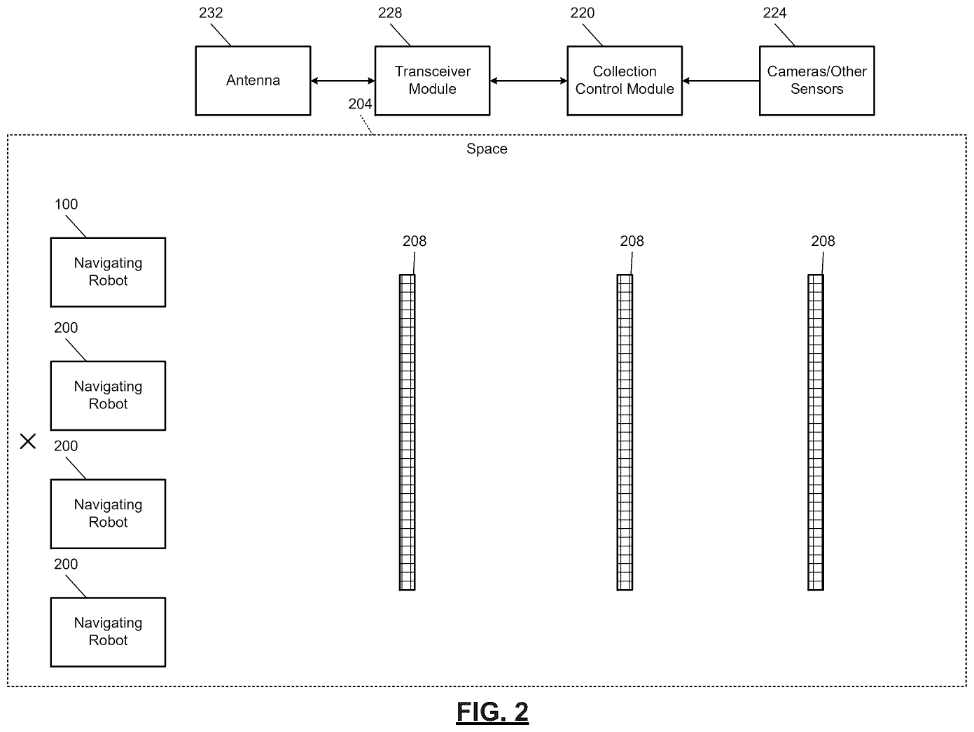

FIG. 2 is a functional block diagram of an example implementation of a collection control system for an indoor space, such as a building, warehouse, etc. As discussed above, the navigating robot 100 and one or more other robots 200 navigate the space 204 to collect items of orders and delivers the items of each order to goal locations or workstations. The navigating robots may be identical to each other in various implementations. Shelves are illustrated by 208. While example numbers of shelves and navigating robots are illustrated, the present application is also applicable to other numbers of shelves and navigating robots. The present application is also applicable to other arrangements of shelves. The present application is also applicable when other static obstacles are present in the space where robots are operating. The present application is also applicable when moving obstacles (other than the planned robots) are present in the space if their position in time and space is known for the planned period. An example workspace is illustrated by an X in FIG. 2. Examples of static obstacles include shelves, desks, fire extinguishers, etc.

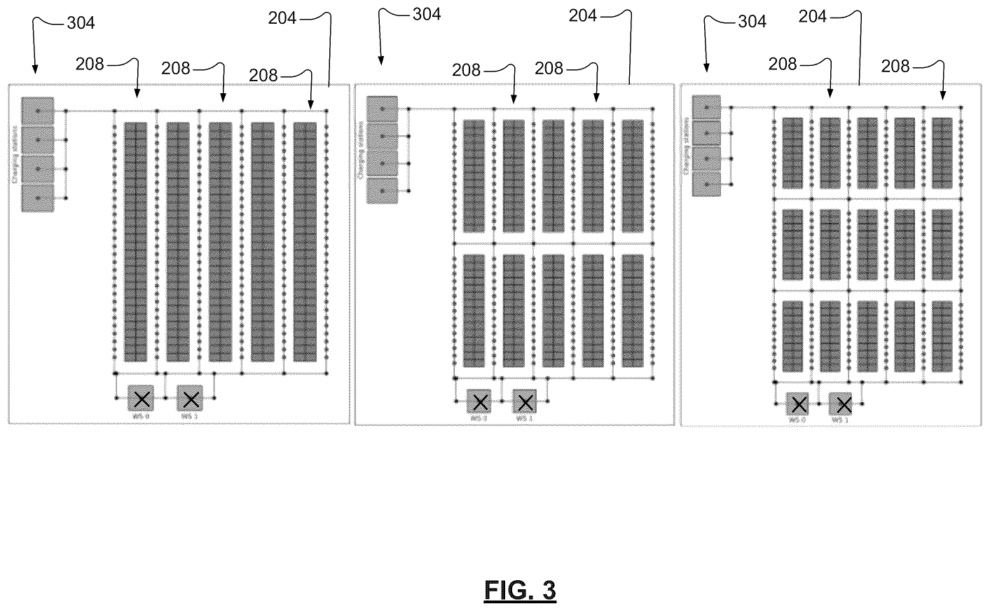

FIG. 3 includes three examples of other arrangements of shelves 208 and workspaces X. FIG. 3 also includes example stations 304, such as charging stations or goal locations.

Referring to FIGS. 2 and 3, a collection control module 220 controls movement of the navigating robots in the space 204 to collect items for orders respectively allotted to the navigating robots. In various implementations, one or more cameras and/or other sensors may be used within the space 204 (e.g., overhead), such as to monitor positions and movement of objects (e.g., the navigating robots and other types of objects) in the space 204.

The collection control module 220 communicates wirelessly via the navigating robots via one or more transceivers, such as transceiver module 228, that are configured to wirelessly communicate via one or more antennas, such as antenna 232. The collection control module 220 may communicate with a navigating robot, for example, to provide commands for motion from the navigating robot, to receive position information of the navigating robot, and for one or more other reasons.

The navigating robots may be referred to and are types of as agents. Agents may be things that can follow or approximately follow communicated trajectories/paths. The navigating robots may be differential drive robots in various implementations and, as discussed above, be configured to move forward, backward, and turn in place. The navigating robots may include one or more actuators to pick-up (and drop-off) objects to and from shelves and stations. The navigating robots may include one or more actuators to perform actions that can be specific to one or a set of locations (e.g., if the action is watering a plant, it can only be performed when positioned close enough to the plant). Actions, including but not limited to pickup and drop off of an object, may in various implementations only be performed when the navigating robot is not moving (zero speed).

The collection control module 220 may include a dynamics model for the navigating robots so that the trajectory and travel time to go from an initial state (e.g., position and speed) to target state as well as the time to perform actions can be determined by the collection control module.

Regarding a graph of the space, the graph of the space 204 may be a general directed graph Gw=(Vw, Aw). The vertices (or nodes) of the graph are associated with the physical locations where a navigating robot can either stop to pick-up and drop-off objects (e.g., in front of shelves and workstations) or turn (in case there is enough space). Example vertices (or nodes) are illustrated by the dots in FIG. 3.

Mathematically speaking, arcs may be oriented edges. In the warehouse graph, edges (e.g., not arcs) are included, while in the routing graph, arcs (e.g., not edges) are included. Arcs and edges represent segments to be traveled between vertices. Lines between vertices illustrate example arcs or edges in FIG. 3. In various implementations, the graph may not be simply a rectangular grid (although it may be). Not requiring the graph to be a rectangular grid does not impose any restriction on the warehouse layout or the distance between vertices. This generality may lead to cases where a robot may occupy multiple vertices and arcs simultaneously. Although this graph is not used directly by the collection control module 220, it represents input data used to build the more complex routing graph described below.

The collection control module 220 assigns orders to the navigating robots. An order may refer to a set of tasks, each task being composed of a sequence of actions that are each to be performed at a given location. For example, an order may refer to a set of objects to be picked up at some shelves and dropped off to a (e.g., single) workstation; or in the opposite, multiple objects at a workstation are to be dropped off to one or more different shelves. In this example, a task is the displacement of an object and the list of actions that are associated with this task contains a pickup and a drop off action. In various implementations, multiple objects may be transported from one or more shelves to one or more other shelves. Orders are received by the collection control module 220 at different times, such as via the Internet or another suitable network.

In an implementation where tasks are pickup and delivery of an object, an order o∈O with k objects is defined as a tuple

$$( {r}^{o} , \{ ( {p}_{1}^{o} , {d}_{1}^{o} ) … , ( {p}_{k}^{o} , {d}_{k}^{o} ) \} )$$

where ro is the release date of the order,

$${p}_{j}^{o}$$

the vertex corresponding to the location of the shelf where the j-th object is to be picked-up or delivered and

$${d}_{j}^{o}$$

is the duration of the corresponding pick-up or delivery action. A duration for the action (pick-up or delivery) performed at the workstation for each object can also be defined, either as workstation or object specific. Duration could also be object specific or be robot specific at the shelves and could also be robot specific at the workstation.

In an implementation where tasks are pickup and delivery of an object, a task may refer to a navigating robot picking-up an object at an initial location and delivering it at a target location. The set of tasks that correspond to a given order are said to be interdependent because they share the same workstation as initial or target location and their pickup or delivery actions at the workstation must all be finished before the workstation can be used for another order. In other words, when tasks share the same workstation as initial or target location, they are said to be interdependent since one or more of the tasks' actions must all be finished before the workstation can be used for another order.

Actions may involve additional resources to be used by the robot. For instance, if an order requires one or multiple robots to pick up several objects at a station and deliver them to shelves, the station resource may be used perform the pickups. It may be occupied by the objects of the order until the last one has been removed and may not be used for any other order until that time. In various implementations, some resources have a non-unitary capacity and can be shared between orders, tasks or actions, respecting the maximum number of orders, tasks or actions that can use it simultaneously defined by the resource capacity. In various implementations, an order, a task or an action may use several resources simultaneously. A resource for an order may be a resource for any action of that order and a resource for a task is a resource for any action of that task.

In the above example implementation, for tasks consisting in two actions: pickup an item at a station and delivering it at a shelf, the station is occupied by a first order as long as one object of the first order remains on the station. The station is then a resource for the first order. Supposing that only the items of a single order can remain on a station, the station is used for the pickup actions of the first order and for the pickup actions of the next order using this station. In that case, the pickup actions of the second order can only start (by putting the corresponding objects on the station for pick up) once the last pickup of the first order is finished. A precedence constraint exists between any pickup action of the first order and any pickup action of the second order in the sense that no pickup action of the second order can start before all the pickup actions of the first order are finished.

More generally, a precedence constraint (aᵢ, a′ⱼ) between action aᵢ of task a and action a′ⱼ of task a′ may be defined by the constraint stating that aᵢ must be finished for at least δ_{i,j}>0 time units when a′ⱼ starts. Precedence constraint (a, a′) between task a with sequence of actions (a1, a2, . . . aK) and task a′ with sequence of actions (a′1, a′2, . . . a′K′) may be defined by the set {(aᵢ, a′ᵢ)|1≤i≤K, 1≤j≤K′} of precedence constraints between actions of a and actions of a′ or any subset of precedence constraints of that set. In the context of this application, when the precedence constraint (a, a′) between task a and task a′ exists, (a′, a) is empty. We can define similarly a precedence constraint (o, o′) between order o and order o′ based on the existence of precedence constraints between actions or tasks of o and o′.

Regarding MAPF with interdependent tasks, given a set of agents (navigating robots), a warehouse graph and a stream of orders and their associated tasks, a goal of the collection control module 220 is to find a sequence of collision-free trajectories for the agents to execute their tasks, such that only one order is handled at a workstation at a time and the throughput is maximized, mean order time may be minimized, and/or regret may be minimized. In some applications, other optimization criteria may be considered.

The MAPF problem with interdependent tasks includes two optimization subproblems: (i) Task Assignment: which involves which agent should execute each task and which workstation should be used for each task (order); and (ii) MAPF: how should the agents move (in space and time) to execute their tasks. These two interdependent subproblems may be considered separately by the collection control module 220. To deal with the stream of orders, the collection control module 220 may solve/update the subproblems at predetermined (e.g., user-specified) intervals. More specifically, the collection control module 220 may find a solution for a new instance of the same subproblem each time, but the sub problem (e.g., MAPF) may identical, and the instances will share the same environment but not necessarily the same agents and most of the time different orders.

The collection control module 220 determines a plan and starts executing it at a time; then plans again, given the current state of the system including the newly released orders, and so on. In the following, for simplicity one planning/execution iteration will be discussed. For each iteration, the orders are known and an objective of the collection control module 220 is to minimize the makespan, i.e. the maximum completion time of all the known tasks, minimize completion time, minimize regret, and/or achieve one or more other objectives.

The MAPF algorithm used by the collection control module 220 may be referred to as interleaved prioritized planning. The via-point star (VP*) algorithm is used by the collection control module 220 for routing agents without collision, starting by the graph model and collision checking that enable the collection control module 220 to manage the navigating robots' dynamics. The VP* algorithm takes a graph as input (referred to as a routing graph) and those arc weights are precomputed using the robot dynamics. Using a collision checking module of the collection control module 220, the collection control module 220 may, based on the robot's dynamics, check for a given displacement of a robot following one arc if the robot collides with any other robot based on information saved in a collision table. In various implementations, other collision checking methods may be used to verify if the displacement of a robot collides with any other robots based on information on previously planned robot displacements. In various implementations, the collision checking may be based on moving object displacements and previously planned robot displacements.

To optimize the task assignment, the collection control module 220 solves the underlying idealized scheduling problem where it is assumed that the navigating robots use the shortest paths, ignoring potential collisions. There can be several paths of identical minimal arrival time. The navigating robot may use any of those. The collection control module 220 may use a rule-based heuristic. For example, the collection control module 220 may decompose the system state S into the agents state S^{agents}:={(τ^{a},ν^{a}): a∈A} where τ^{a} is the time when agent a will be available and ν^{a} its position (vertex) at time τₐ; and the workstations state S^{ws}:={τ^{w}: w∈W} with τ^{w} the times when each workstation will be available. The assignment is based on the problem above. The VP* algorithm will work whatever the assignment is made.

At the beginning of a day, agents are at their initial positions and availability times are zero. Orders are sorted by the collection control module 220, such as in a First In First Out (FIFO) fashion, by increasing released date (date and time of receipt). For each order, the collection control module 220 assigns the earliest available workstation. For each task of the order (corresponding to a pick-up and delivery), the collection control module 220 assigns the earliest available agent and updates its state, based on the product pick-up and drop-off times and the ideal travel times. After assigning all the tasks of an order, the collection control module 220 updates the availability time of the workstation, and switches to the next order.

To avoid congestion at the workstations, the collection control module 220 may limit the number of agents assigned to one order. From the complete schedule, the collection control module 220 may extract the assignment of the orders to the workstations and the sequence of tasks assigned to each robot.

In a different prioritized planning (PP) algorithm, the collection control module 220 may give the agents a predetermined priority order then, in descending priority order (start with the robot of highest priority and continue with the second highest priority robot and so on), the collection control module 220 may determine the shortest path for each agent, avoiding the trajectories of the previously planned agents (considered as moving obstacles). The collection control module 220 therefore determines the shortest path for each robot separately in descending priority order and based on kinematic constraints.

Consider an example scenario of 3 navigating robots, 1 workstation, and a sequence of 10 orders, each order including 3 items. To process the orders as fast as possible, the collection control module 220 may divide the tasks (picking of items) of each order between the robots. With PP, after planning the 10 pick-ups and deliveries of the 1st and 2nd robot, the last planned robot may incur delays (e.g., due to the numerous moving obstacles). In this case, one cannot guarantee that objects from different orders are not mixed at the workstation due to multiple robots being used to satisfy the same order in concert.

The present application avoids this situation by using the Interleaved Prioritized Planning (IPP), where the priorities are dynamically assigned by the collection control module 220 throughout the planning process, as follows.

Based on the task assignments, the collection control module 220 reinitializes the agents and workstation states, and adds to each agent's state its assigned sequence of tasks; and for each workstation, its assigned sequence of orders. For each order (sorted by the FIFO rule), the collection control module 220 considers the subset of agents assigned to (the tasks of) this order.

The earliest available agent a is assigned the priority for path planning by the collection control module 220. This agent's path is set by the collection control module 220 to visit the sequence of goal locations of its next task t and, optionally, finish at its waiting location (e.g., workstation). To determine its start time, the collection control module 220 takes into account the availability time of the relevant workstation. The start time and list of goal locations are input to the VP* algorithm discussed further below and executed by the collection control module 220 thereby computing a trajectory for the agent that avoids collisions with previously planned trajectories.

Given the trajectory, the collection control module 220 updates the availability time of the agent and workstation, and discards the task t from the agent's a tasks. The collection control module 220 updates the previously planned trajectories with the complete trajectory information, including the last part of the path (that goes to the waiting location). The collection control module 220 repeats until all the tasks of the order are planned and then switches to the next order.

The last part of each path is optional in the sense that if a robot can directly depart from the delivery location of its previous task to the pick-up location of its next task then the collection control module 220 may discard the go-to-waiting-spot part of its path to save time and increase throughput. However, this part can be used and maintained (go to waiting spot) and may ensure that a feasible solution is always found.

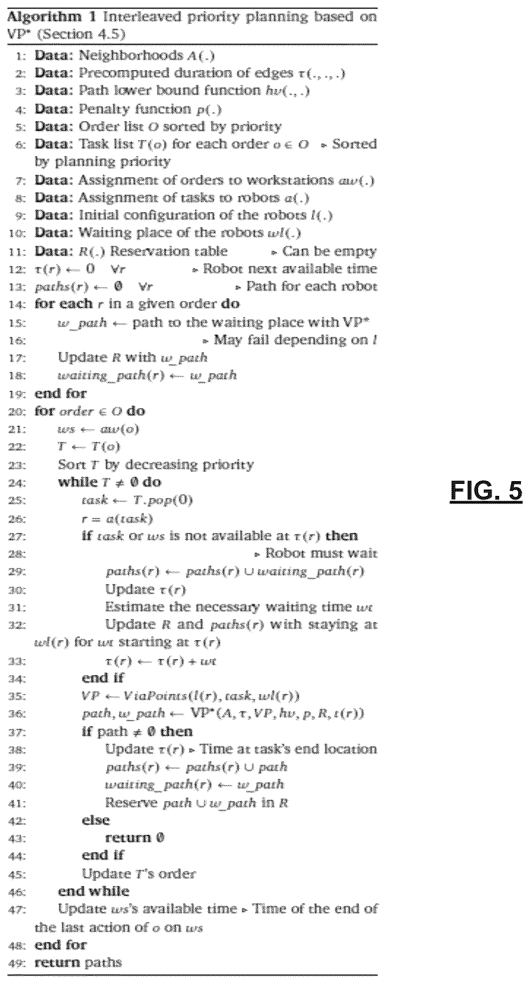

A detailed pseudo-code for the IPP performed by the collection control module 220 is provided in FIG. 5.

Lines 1-12 involve input data of the algorithm. For example, Line 1 involves neighborhoods A(v) of any vertex v in the routing graph. Line 2 involves the duration τ(ν,ν′,l) of each arc (v, v′) when the robot is loaded (l=1) or unloaded (l=0). Line 3 involves the path time lower bound function h̅(ν,ν′,l) between any two vertices v and v′ when the robot is loaded (l=1) or unloaded (l=0). Line 4 involves the penalty function p. Line 5 involves receiving a list O of orders and sorting or are pre-sorted according to priority. Line 6 involves a task list (items to collect) for each order. Workstations assigned to orders are referenced in Line 8. Tasks assigned to specific navigating robots are referenced at Line 9. Initial configurations of the navigating robots, including but not limited to locations and orientations of the robots, are referenced at Line 10. Along the execution of the IPP algorithm, I(r) is updated to contain the configuration of robot r from which the next path is computed (e.g., configuration after the last planned delivery). Line 11 involves waiting locations wl for the navigating robots. Line 12 involves the reservation table (R) which may be empty at the beginning of the planning. The reservation table will contain something as soon as the path of the first task is reserved, so before the first order is completed, started, or even fully planned. In some implementations, the reservation table can be initialized with path reservation for known moving obstacles (e.g., a robot whose moves are not to be planned).

Line 13 involves setting the availability time of each robot to the time of the beginning of the planning (e.g. time 0). When the reservation table is not empty, this could be obtained from the configuration of the robots (line 10).

Line 14 involves initializing each robot path to the empty set.

Lines 14 to 20 involve computing for each robot r in a given order (e.g. provided as input of the algorithm) a path from its starting position and orientation (given by its initial configuration I(r)) to its waiting place wI(r); updating the reservation table with this path and saving it for possible later use.

Lines 21 to 50 involve iterating on each order o in decreasing priority order to compute the paths related to each task of this order.

Line 22 involves retrieving the workstation assigned to order o.

Line 23 involves retrieving the tasks of order o.

Line 24 involves sorting those tasks in decreasing priority order.

Lines 25 to 47 involve iterating other the tasks of T to compute the path of the assigned robot when processing this task.

Line 26 involves retrieving from the tasks remaining to be planned the task with highest priority.

Line 27 involves retrieving the robot r assigned to that task.

Line 28 involves checking if the robot can start processing the task immediately at the end of its previous task.

Lined 30 to 35 involve, when robot r cannot start processing the task immediately, adding to going to wait to its waiting place to its path for a given duration, updating the reservation table and the robot availability time accordingly.

Line 30 involves adding the precomputed path to the waiting place of robot r to the path of robot r.

Line 31 involves updating the availability time of the robot with the arrival time of r at its waiting place.

Line 32 involves computing an estimation wt of the waiting time of the robot r at its waiting place for ensuring that it does not arrive at the workstation before the previous ticket (order) is finished.

Line 33 involves updating the reservation table and the path of robot r with staying for wt at wl(r).

Line 34 involves increasing the available time of r of wt time units.

Line 36 involves obtaining the list VP of via points associated with the current configuration I(r) of robot r, with the current task and with waiting place wl(r) of robot r.

Line 37 involves using the VP* algorithm to compute the shortest path associated with the list VP of via points.

Line 38 involves checking if the VP* has been able to return a path.

When the VP* has been able to return a path, lines 39 to 42 involve saving that path at the end of the path of robot r (Line 40), update the waiting path of robot r (Line 41) and save the path and the waiting path computed by the VP* algorithm to the reservation table.

Line 48 involves updating the workstation ws's available time with the end time of the last action of order o that is performed on ws.

Line 51 involves returning the computed paths.

Assume that each robot has a designated waiting place, where it can be idle without interfering with other robots' trajectories. If the robots are at their waiting place at the beginning of the planning, the IPP algorithm is complete. To show that the algorithm is complete, proof is needed that the IPP algorithm always returns a feasible solution (paths for the robots that respect all constraints). There are two constraints to consider: (i) the paths of two robots must not collide and (ii) all the tasks of an order must be finished on its workstation before any new task can start on that workstation. In various implementations, other time precedence constraints on tasks and order could be considered. The robots may start at their waiting place. The planned trajectories may include reservation of those waiting places by the robots for the planning horizon and no other information. Hence, in this setting, each robot can wait for an unlimited time at starting position without blocking the way of the other robots. Consider the first task o_{1,1} of the first order o₁ assigned to robot r, that is released at time

$${τ}_{1}^{0} .$$

Its assigned workstation w is either available for order o₁ or will be available at a given time τ^{w}. We can compute, given r's availability time τ^{r}, the earliest time τ at which it can start to perform the task to respect those availability constraints, assuming the agent doesn't wait once it has left its waiting place, using a shortest path algorithm or via-point search.

The algorithm of FIG. 5 plans the navigating robot to wait until r and then computes a path starting at r for the via-points for the task plus a return for the robot to its waiting place. As there is no other robot for which a move is planned, such a path, respecting constraint (i) above always exists, assuming the graph is connected. By definition of τ, it also respects (ii) above. The collection control module 220 updates the available time τ^{r} of the robot with the task's end time, so that it can restart from its last position. If the order has other tasks, the same availability time τ^{w} may be used by the collection control module 220 for the workstation when determining when to start from the waiting place. The time τ determined is then an optimistic estimate based on travel times without collision from the robot's current location. It ensures (ii) is satisfied as the robot can only arrive later than τw at the workstation if it needs to avoid other robots. If the robot needs to wait, the collection control module 220 may send it to wait at its waiting place: if it is different from its current position, the collection control module 220 may reserve a path to go to the waiting location during the planning of the robot's previous task. Constraint (i) is then ensured by the existence of a feasible path: the robot can always wait for all the planned trajectories to be finished to move. When all tasks of an order have been planned by the collection control module 220, the collection control module 220 updates the availability time of the workstation with the end time of the last action of the order, ensuring that no task of another order is able to start before that time. Tasks of the next order can hence be planned by the collection control module 220 following the same logic and respecting the constraints. Note that the above also holds true when the robots start at locations other than the waiting places and either a path is reserved in the planned trajectories from their current position to their waiting places, or such a path can be determined for each agent in a priority order given to the algorithm for initializing the planned trajectories.

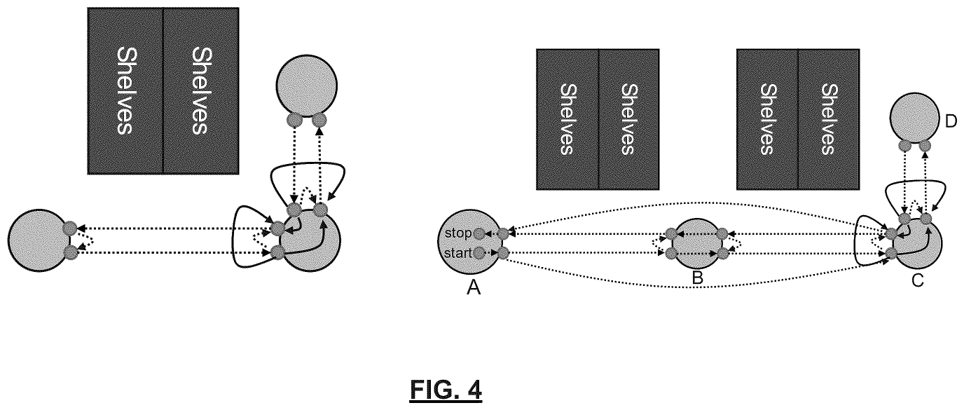

FIG. 4 includes an example illustration of routing graph nodes and arcs. Original nodes in the warehouse graph are illustrated in blue, while new routing nodes are illustrated in orange. Dashed lines represent straight arcs despite some being curved for illustration, while solid lines represent turning arcs. The solid turning arcs within node C represent two arcs each, one for turning counterclockwise and one for turning clockwise.

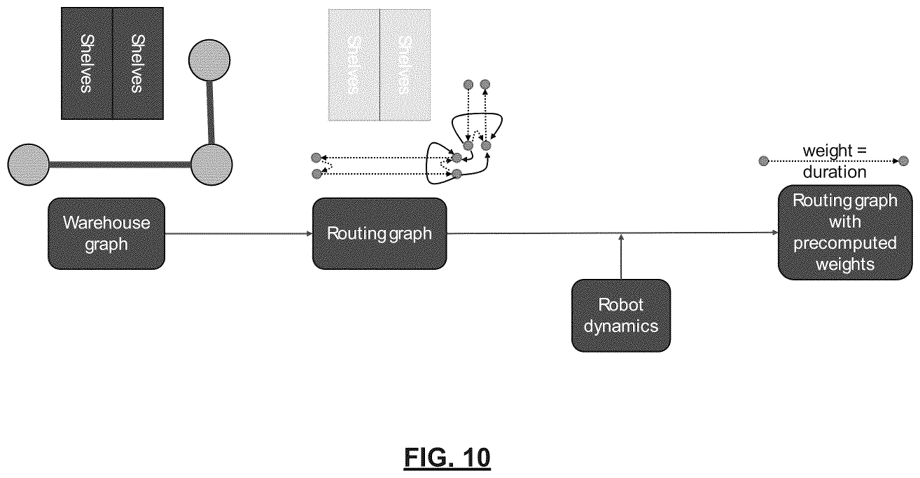

Routing could be performed directly in the warehouse graph Gw, such as shown in FIG. 3. However, as a robot may occupy several nodes, may not be able to turn everywhere, may take time to turn, and may have non trivial dynamics, the collection control module 220 creates a specific routing graph that can integrate those elements in its structure. To do so, the collection control module 220 may convert the warehouse graph Gw, to a directed routing multi-graph in which each vertex (e.g., node C in the FIG. 4) of Gw is represented with several vertices of different types and their associated arcs: (i) a start and a stop node, to start planning from that position or end an itinerary at that position (only shown for node A in FIG. 4); (ii) for each adjacent node in the warehouse graph (like node D), the collection control module 220 creates two nodes: one for arriving from that node and one for going to that node. They are linked by an additional arc allowing for going backward without changing direction; (iii) where it is possible to turn, the collection control module 220 adds turning arcs for the robot to reverse its orientation (i.e., perform a U-turn); (iv) at the nodes (like node C) where two nonparallel edges meet, the collection control module 220 adds two turning arcs per node-triplet (two for nodes B-C-D, and two for nodes D-C-B), one for turning clockwise and one for turning counter-clockwise. One of these arcs also turns the traveling direction of the robot. The robot may stop in order to turn, to avoid sliding, tilting and dropping a potentially heavy load. However, if the robot is going straight, the collection control module 220 may control it to traverse long paths without stopping, possibly passing through several nodes. To this effect the collection control module 220 may augment the routing graph with additional shortcut edges between nodes that are on a straight line. With shortcuts in place, the collection control module 220 may set the initial and final linear and angular velocities at all the nodes to zero. The collection control module 220 may use the robot's dynamics to associate two travel times with each arc: one for an empty robot (carrying no items) and one for a loaded one (carrying one or more items for an order). The times for each arc traversal may be determined by the collection control module 220 based on accelerating the robot to a predetermined maximum linear/angular velocity within the edge-specific speed limits and decelerating back to speed zero. In various implementations, other speed constraints and acceleration and deceleration schemes may be used, them possibly being different for different arcs of the graph. When the speed at each node is zero, and arc travel times are fixed, computing a shortest path without moving obstacles for a single robot may be performed by the collection control module 220 using polynomial (as opposed to the general case of shortest path with kinematics). The collection control module 220 may use this property to rapidly determine the lower bounds on the duration of paths avoiding collision. In various implementations, the conversion from warehouse graph to routing graph may be done by a conversion module, which may be external to the collection control module 220. FIG. 10 illustrates the conversion of the warehouse graph into the routing graph.

Regarding collision checking and avoidance, the collection control module 220 may take a strong hypothesis on the routing graph are to avoid robot collision. Under this hypothesis, robots in adjacent nodes cannot collide, and rules on robot movement may be enforced by the collection control module 220 to ensure that collisions are avoided when determining the paths. In the routing graph determined, adjacent nodes can be so close that two robots occupying them would collide, or so far away that two robots traveling the same edge would not collide.

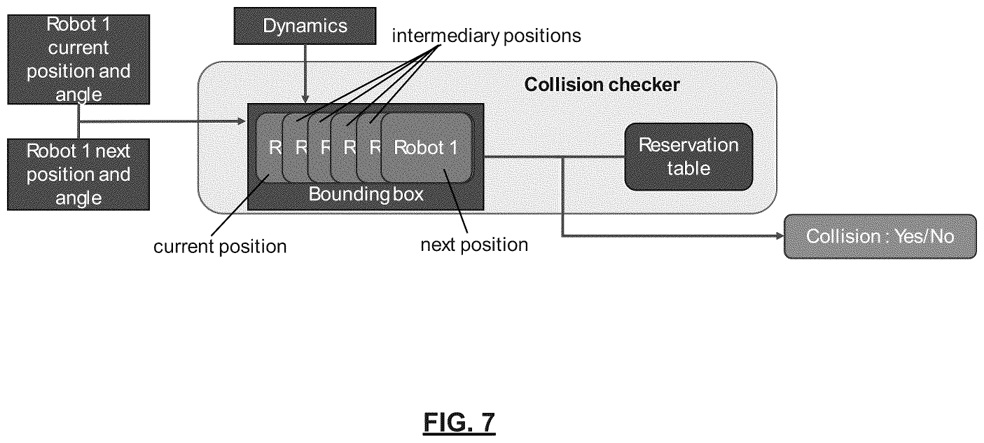

The collection control module 220 may therefore enforce a more spatially explicit collision checking method. The position xy∈ [symbol] ² of each robot and its orientation (yaw) θ∈[−σ, π] is uniquely determined (e.g., by the collection control module 220 or by the robot itself via one or more sensors) at each time τ. In the routing algorithm, the configuration of the robot may be defined as a tuple (τ, x y, θ, s, sθ, l), where s∈ [symbol] is the linear velocity in direction θ, sθ∈ [symbol] is the angular velocity, and l=1 if agent is loaded and l=0 otherwise (not loaded). For collision detection, the space occupied by the robot is modeled by the collection control module 220 as a connected two-dimensional set (such as a polygon) centered at its x y-position and rotated by its orientation. Such a set may include additional padding. This is illustrated in FIG. 7. The collection control module 220 computes a bounding box around the robot's displacement using the dynamics and determines whether that bounding box intersects with any bounding box of another robot in the reservation table. The bounding box of the same robot may intersect (e.g., when using spatial or temporal margins). The reservation table can be input or output, such as parameters or fields of the object.

As illustrated in FIG. 7, the collision checking involves use of the reservation table that includes stored planned trajectories (e.g., including times and places at those times) for navigating robots. Planning a new path for a robot X proceeds edge by edge in the routing graph, so when considering travelling an edge from current position and angle to the next position and angle, the robot X's trajectory is first calculated by the collection control module 220 based on the robot dynamics and then collision checking is performed by the collection control module 220 by comparing each determined piece of robot X's trajectory (each time and location) to the trajectories (times and locations, respectively) of the other robots in the reservation table. This check can be performed by the collection control module 220 by dividing the time during which the robot X traverses the edge to fixed intervals (e.g., one second or another suitable period) and determining the robot location in the beginning of an interval I and in the end of the interval I and reserving a bounding box of these locations for the interval I. If the collection control module 220 identifies a collision (e.g., at least partial overlap) at a time of a bounding box with a bounding box of another trajectory in stored to reservation table, the collection control module 220 discards the edge and tries the other possible edges to determine a new path for the robot X.

At any given time τ, the collection control module 220 may check if the spaces occupied by two different robots intersect. For example, the collection control module 220 may cut continuous time into intervals, and model the space occupied by the robot during the interval as (e.g., a superset of) the union of the sets the robot occupies during each interval. Checking if a robot would collide with other robots at time τ can then be conservatively approximated by the collection control module 220 by checking if the space occupied by the robot intersects with the spaces of the other robots occupied during the interval containing τ. The collection control module 220 may also add some time safety margin by reserving some neighboring intervals.

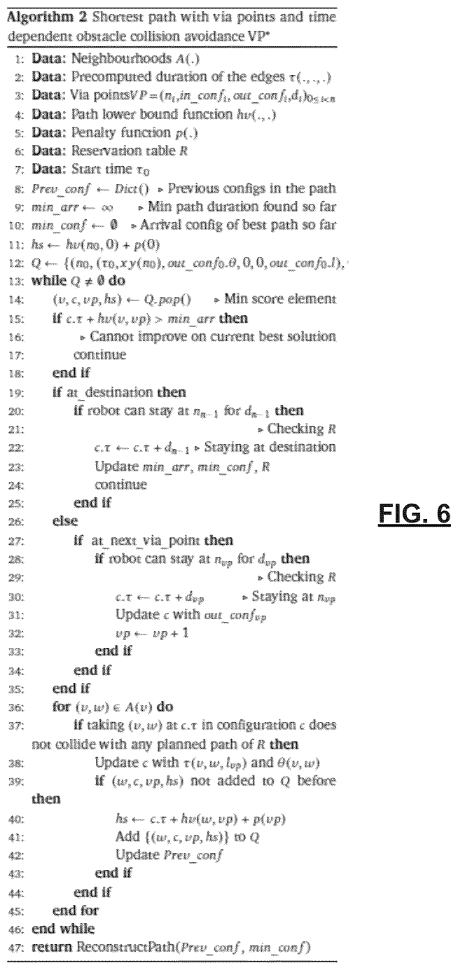

FIG. 6 includes pseudocode for an example implementation of the VP* Algorithm executed by the collection control module 220, such as line 36 of the example of FIG. 5.

Lines 1-7 involve input data of the algorithm. For example, Line 1 involves neighborhoods A(v) of any vertex v in the routing graph. Line 2 involves the duration τ(ν,ν′,l) of each arc (v, v) when the robot is loaded (l=1) or unloaded (l=0). Line 3 involves the via points that must be passed sequentially in the returned path, with their associated node vᵢ, their in-configuration

$${c}_{i}^{i n}$$

containing, but not limited to, the required orientation when arriving at via point i, their out-configuration

$${c}_{i}^{out}$$

containing, but not limited to, the required orientation

$${c}_{i}^{out} \cdot θ$$

when leaving via point i and the load status

$${c}_{i}^{out} \cdot l$$

when learning via point i, and the action duration dᵢ at via point i. Line 4 involves the path time lower bound function h̅(ν,ν′,l) between any two vertices v and v′ when the robot is loaded (l=1) or unloaded (l=0). Line 5 involves the penalty function p. Line 6 involves the reservation table R. Line 6 involves the start time τ₀ of the path to be computed.

Line 8 involves initializing the dictionary of the previous configurations that returns for a given robot configuration the configuration at the previous vertex in the path.

Line 9 involves initializing the minimal arrival time of a solution found so far by the algorithm to infinity.

Line 10 involves initializing to unknown the configuration used to retrieve from Prev_c the path corresponding to a solution of minimal arrival time among the solutions found so far by the algorithm.

Line 11 involves computing the initial configuration of the robot at the beginning of the path.

Line 12 involves computing the heap score of the initial configuration.

Line 13 involves adding an element corresponding to this initial configuration to the queue, with via point index equals to 0 (only the first via point has been passed).

Lines 14 to 46 involve iterating over the queue elements in increasing heap score order.

Line 15 involves popping out of the queue (e.g., selecting) the element of lowest heap score.

Line 16 involves checking if the optimistic estimate of the duration of a path from the configuration of the element to the destination is higher than the minimum arrival time of a solution found so far by the algorithm. Line 18 involves going to the next queue element if it is the case.

Line 20 involves checking if the element corresponds to reaching the destination via point.

When it is the case, Line 21 involves checking if the robot can stay there for the required time using reservation table R. If it is the case, Line 23 involves updating the minimum arrival time and the corresponding configuration and Line 24 involves going to the next queue element.

Line 27 involves checking if the element corresponds to reaching the next via point.

When it is the case, Line 28 involves checking if the robot can stay there for the required time using reservation table R. If it is the case, lines 30 to 32 involve updating the configuration and incrementing by one the via point index for the next queue elements generated from the current configuration at lines 36 to 45.

Lines 36 to 45 involve iterating in any order on the out arcs in the routing graph of the node v of the current heap element.

Line 37 involves checking if traveling arc (v, v′) of A(v) at time c. x does not collide with any planned path of R. If not, Line 38 involves computing the new configuration c′ at node v′ obtained from c by traveling the arc (v, v′) and obtaining at line 39 a tentative new queue element. Line 39 involves checking if that new element has already been added to the queue before. If it is not the case, lines 40 to 42 compute the heap score the new queue element, add it to the queue and update the dictionary of previous configurations.

Line 47 involves reconstructing the optimal path from the dictionary Prev_c of previous configurations and the saved min_c configuration.

To plan the displacements of the robot for a given task, the collection control module 220 may determine paths that take into account not only the position of static obstacles (modeled into the graph with non-existing edges) but the positions of the other robots, which are moving in the space at the same time as the collection control module 220 plans the navigating robot's path. Via points. For each task, the collection control module 220 may plan several consecutive displacements of the robot (e.g. going to an aisle between shelves to pick up an item, going to the workstation to deliver the item, moving to a waiting area to wait for the next task, etc.). We call those locations to visit sequentially via points. If a shortest path algorithm with collision avoidance was used sequentially for each pair of consecutive via points, there may be no guarantee of finding a path for all the displacements of the sequence. Taking the shortest path for the first pair of the sequence may prevent the robot finding any feasible path to the remaining via points. In the present application, the collection control module 220 determines in a single computation instant the shortest path by passing the sequence of via points based on robot dynamics, actual robot load, and position and orientation in space, and it bases collision checking on vertex and swapping conflicts.

Even if the arc weights are precomputed, based on the robot's dynamics, the collection control module 220 may use precise displacement information when checking collision for the current robot against already planned robot paths (moving obstacles), which impacts the speed of the algorithm. The space occupied by the robots along their planned paths are computed by the collection control module 220 and stored in the reservation table for later collision checking when other paths for other robots are computed.

The orientation of the navigating robots may be important: in order to pick up or drop off objects at the shelves and workstations (or when performing different actions in various implementations), the robot might need to be in a specific orientation to execute the (pick up or drop off) action. However, due to space constraints, it may not be possible for the robot to rotate in the aisle, so a proper orientation when entering the aisle may be needed. When orientation must be known or controlled, orientation may be taken into account by the collection control module 220 in the configuration of the robot, and also in the description of the via points and in the routing multi-graph. In addition, the speed of the robot might be different when loaded, so the collection control module 220 may use the load that may also be added to the via-point information. Each via point can be defined by a node in the graph (and physical position), a partial in configuration indicating the required orientation (yaw) and the load when arriving at the node, and a partial out configuration indicating the required orientation and the load when leaving the node, and the time required at the via point to perform the associated action. The via points may be the only points where the robot can perform an action. In various implementations, one or more parameters may not be used in the via point description, such as load, orientation, and/or one or more other parameters.

The collection control module 220 may determine the shortest path by passing a sequence of two or more via points. An objective is to find an earliest arrival path starting from the first via point and then passing by each via point in the order of the sequence, and arriving at the last via point while respecting the constraints imposed by the partial configurations of each via point, stopping at each via point for a period defined for each via point, and avoiding collision with the moving obstacles whose configuration is known at each time instant from the reservation table. In various implementations, the only moving obstacles may be the other navigating robots. However, the collision checking could be performed by the collection control module 220 similarly for any kind of moving obstacle whose occupied spaces are stored in the reservation table.

Travel time may be either continuous or discrete with high precision to avoid cumulative errors over multiple paths computed sequentially during the planning. To reduce the computation time, when the robot is waiting at a given point, the waiting time may be discretized by the collection control module 220 to the second. When waiting at a node is possible, the graph may include an additional arc from the node to itself with a duration equal to a chosen minimum waiting period.

G=(V, A) may denote the routing graph where V is the set of nodes and A the set of arcs between those nodes. For a given node ν, A(ν) denotes the output arcs of ν, i.e. the set of arcs {(v,w)∈A|w∈V}. The weight τ(a, l) of an arc (v, v′) is the time duration to travel along the arc (v, v′) with l=1 if the robot is loaded and 0 otherwise. The angle θ(v, v′) is the rotation angle of the edge when the edge allows to turn in a given direction, and 0 otherwise. A path is a succession (ν0, ν1), (ν1, ν2), . . . (vi−1, vi) of arcs of A.

The duration of a path p is Σ_{v,v′∈p} w(v,v′,l). To obtain a lower bound h(ν, ν′, l) for the duration of a path between node ν and node ν′, the collection control module 220 may determine the duration of the shortest path p under the assumption that there is no obstacle (one duration for a loaded robot and one for an unloaded robot), and without any requirement on orientation at node v′, using a shortest path algorithm, such as the shortest path algorithm described in J. Li, et al., Lifelong Multi-Agent Path Finding in large-Scale Warehouses, in Proceedings of the AAAI Conference ion Artificial Intelligence, 37(10):11578-11585, 2023, which is incorporated herein in its entirety. The collection control module 220 may determine the shortest path in polynomial time, using the graph determined as discussed above. When passing by k via points, those respective associated nodes are ν1, ν2, . . . , νk, the estimate h((ν=ν₀,ν₁,l₁,)(ν₁,ν₂,l₂,), . . . , (νₖ, ν′=νₖ₊₁,lₖ₊₁)) is the sum of the estimates of the sub paths, i.e. Σ_{0≤i≤k} h(νᵢ,νᵢ₊₁,lᵢ)+dᵢ where di is the time/period spent at each via point.

As stated above, VP* algorithm of the collection control module 220 is illustrated in FIG. 6. This algorithm iterates on a priority queue, which directs the search toward the most promising elements. The priority queue contains tuples (ν, c, νp, fs), where ν is a node, c a configuration at this node, νp the index of the last via point reached and fs the heap score of the tuple. At the beginning of the search, the collection control module 220 initializes the queue with a tuple (ν₀, c₀, νₚ₀, fs₀) containing the origin node ν₀ (the first via point), the initial configuration c₀ (obtained from the partial out configuration of the first via point and the path start time), νₚ₀=0 and the heap score fs₀ of the element. During a search step, the collection control module 220 via the VP* algorithm determines and pops a heap element (ν, c, νp, fs) with the lowest heap score and explores its neighborhood A(ν) in the search graph. The collection control module 220 may first check the lower bound on the duration of a path to the destination from (ν, c, νp). If it is larger than the duration of the best path found so far, the search may be pruned by going to the next step. If not, collection control module 220 may check if the next via point is reached in the right orientation, that is if node v is the next via point and if configuration c has the same orientation as the in configuration of the next via point. If we are at the next via point, the collection control module 220 may determine whether/verify that the navigating robot can stay at node ν without collision for the duration of the action to perform at this via point. If it can, and the robot is at destination, the collection control module 220 can update the earliest known arrival time for the path and go to the next step. If the robot is not at destination, the collection control module 220 may increase the index of the last reached via point and update the configuration time τ with the time spent at the via point before exploring the neighborhood of ν as well as the load from the out configuration of the via point.

For each neighbor ν′ of node ν, the collection control module 220 may verify if we can use arc (ν, ν′) starting at time τ without collision, using the dynamics of the robot to compute its position in time and space while traveling the edge. If there is no collision, the collection control module 220 may check that the obtained configuration at w has not already been added to the queue. If not, the collection control module 220 may determine the heap score and add the new element obtained to the queue. The VP* algorithm may be complete if it stops when the queue is empty. In various implementations, the collection control module 220 may use this or other stopping criteria. In various implementations, additional stopping criteria could be added, such as having found a first feasible path, having popped a maximum number of elements out of the queue, or having spent a certain amount of time. The first drops the optimality of the algorithm, the last two leads to drop the completeness of the algorithm as it can return before finding a first feasible solution when one exists.

In various implementations, the collection control module 220 may stop the search as soon as a first solution is found. In practice, it may be faster as the algorithm doesn't need to empty the queue completely before returning a solution. This may provide good results at the level of the MAPF algorithm, sometimes even better than with optimal paths (empty queue), which may suggest that optimizing locally the path of a given robot might in some cases make it more difficult for the planning of paths of other agents.

The heap score of an element is determined by the collection control module 220 based on or as the sum of an estimate of the shortest path duration to the destination after passing through all via points and a penalty p(vp) that is higher when the number of remaining via points to pass is higher, and equal to 0 when only the last via point remains to be reached. An aim of this penalty is to favor finding a first feasible path between origin and destination passing through all via points by making a depth-first like search. It is hence different than the heap score of other algorithms as the score is not necessarily a lower bound on the duration of a path to destination from the current heap element. However, as heap scores are not being used, and travel time lower bounds are used to prune the search, the VP* algorithm remains optimal if run until the queue is empty.

The VP* algorithm also provides other benefits. As the robots may regularly wait to avoid collision, the VP* algorithm, implemented as described above, may lead to solutions that are optimal in terms of path duration, but may not be satisfactory for a human observer. Spending waiting time immobile or moving is equivalent according to the path duration criterion. When the present application involves discretizing waiting times (by setting the duration of the loop arcs of the graph), it can also happen that movement (instead of waiting in place) may improve the minimum path duration by allowing to return at a node slightly before what would have been possible staying immobile. To avoid this, the collection control module 220 may determine the shortest path based on a secondary criterion, the minimum total time in movement of the robot, that the collection control module 220 uses to break ties between equivalent solutions. The collection control module 220 may also discretize arrival times such that solutions that are close in terms of arrival times are deemed equal according to this criterion. Then, among equivalent solutions for this first criterion, the collection control module 220 may select the solution with the lowest total moving time. More details on how to implement this are provided below.

Due to the discretization and to the ties breaking properties of the secondary criterion, the collection control module 220 obtains solutions of equivalent quality with lower execution times.

In various implementations, other secondary criteria could be implemented similarly, for example, but not limited to, minimum total distance or minimum energy consumption. In various implementations, a list of more than two ordered criteria could be implemented similarly, and checked in a sequence to break ties between equivalent solutions on previously checked criteria. Those criteria may be said to be in lexicographical order as solutions are first discriminated on the primary (first) criterion, then if equivalent on the secondary criterion, then if equivalent on the primary and secondary criteria, they are discriminated on the tertiary criterion and so on until the solutions are not equivalent or are equivalent on all the criteria. In this manner, the criteria may be considered hierarchically.

In various implementations, the collection control module 220 may constrain a robot's linear acceleration A to the interval [Adec, Aacc]. The value of A may depend on the loading state of the robot since a heavier loaded robot may not accelerate as fast as a lighter loaded one. If the robot is always accelerating or decelerating as fast as it can toward a target speed, the collection control module 220 can determine the shortest time ts it takes to travel a line segment of length d when starting with velocity vi and obeying acceleration constraints, segment-specific speed limit V and the maximum speed at the end of the segment Vf. The computations can be made for pure turning arcs in which only the robot's orientation θ changes. In this case, the collection control module 220 may perform the computation with acceleration limits [Aθdec, Aθacc], angular distance dB, and maximum angular speed Vθ.

For all the arcs in the routing graph, the initial and maximum final velocities may equal zero. Using these, the collection control module 220 may determine accurate travel times. In various implementations, maximum linear/angular velocities of 0.2 [m/s; rad/s], and constant (ac/de)celebrations of 0.25[m/s2; rad/s2] when the robot is loaded, 0.5 otherwise may be used.

| | | 2 robots | | 3 robots | | 4 robots | |
|---|---|---|---|---|---|---|---|
| Heap score | | std | penalty | std | penalty | std | penalty |
| Visited | Q1 | 13 | 5 | 58 | 21 | 137 | 46 |
| state | Q2 | 30 | 10 | 109 | 75 | 303 | 74 |
| nb(K) | Q3 | 76 | 22 | 184 | 122 | 485 | 130 |
| Run | Q1 | 24 | 9 | 110 | 38 | 276 | 90 |
| time | Q2 | 55 | 17 | 212 | 75 | 611 | 137 |
| (s) | Q3 | 131 | 39 | 355 | 122 | 1009 | 289 |
| Make- | Q1 | 18 | 18 | 15 | 15 | 13 | 13 |
| span | Q2 | 22 | 22 | 17 | 17 | 15 | 15 |
| (min) | Q3 | 25 | 25 | 19 | 19 | 15 | 15 |

Table 1 illustrates results with and without the imposition of the penalty described above and illustrates that the use of the penalty decreases the number of states visited and runtime. Note that multiple heap elements may correspond to the same location with for instance different arrival times or different orientation.

With large robots, actuation noise may increase a likelihood of movement differing from a planned trajectory. This may lead to collisions especially if the actual movement is slower or faster than planned movement. To reduce this resulting from noise, the collection control module 220 may reserve neighboring time intervals around the actual time for each position of the robots in the reservation table. In other words, when the collection control module 220 reserves an area for the robot for a given instant τ, the collection control module 220 also reserves it for a predetermined number (Δ) of seconds before and after τ. Adding more time margin in planning increases the time to collision in various implementations. Unlike makespan that may be relatively unaffected by the different levels of margin, the planning time increases with bigger margins.

To validate the concepts provided above in realistic use-cases, experiments have been performed in a real warehouse environment with a layout similar to the left-most layout of FIG. 3. Its routing graph includes 668 nodes and 2103 edges. Each experiment involved 2 robots navigating the warehouse. A maximum linear speed and maximum angular speed of 0.2 m/s and 0.2 rad/s was used in the experiments, and constant (ac/de)celebrations of 0.25[m/s2; rad/s2] was used for loaded and unloaded robots in the experiments. In the experiments, robot motion limits were set to 0.8 m/s for linear speed and 0.8 rad/s for angular speed, with constant (ac/de)celebrations of 0.45[m/s2; rad/s2]. Other suitable parameters may be used.

Regarding the move time as the secondary criterion, to implement time discretization, equivalence between multiple solutions in terms of arrival time may be defined. In various implementations, two solutions may be equivalent in terms of arrival time if their arrival times differ by less than a given precision. Note that, in that case when the precision is equal to 0, the solutions are equivalent in terms of the criterion if they are strictly equal. In other implementations, the time horizon may be split in consecutive intervals of identical size and two arrival time values lying in the same interval may be considered equivalent. In the experiments, a precision of 2 s was used, which corresponds to the width of an interval, although other precisions may be used.

The VP* algorithm may be modified as follows to take into consider the secondary criterion. First, the secondary criterion's value, e.g., move time, may be added to the weights of the different graph arcs of the routing graph. This allows for fast computation of the secondary criterion's value of partial solutions by the collection control module 220 by updating it incrementally, for example in the case where the total move time is the secondary criterion, it could be incremented as is done for the arrival time. The secondary criterion value may be stored in queue elements by the collection control module 220 and may be used to compare a tentative new element to all the elements previously added to the queue. Instead of checking if a queue element has already been added in the queue with the exact same values, the collection control module 220 may check when all other values are equivalent, if an element with lower or equal secondary criterion value has already been added to the queue. When at destination, the collection control module 220 may update the minimum arrival time and the minimum move time if the current solution is better than the current best path in terms of arrival time or if it is equivalent and better in terms of secondary criterion value. For pruning, when checking if current heap element can improve on current best path, the collection control module 220 may ensure that the arrival time is lower or, if the arrival times are equivalent, that secondary criterion value is lower for a secondary criterion to minimize or higher in the case of secondary criterion to maximize. Due to the discretization, the number of states visited may be reduced in the two-criteria implementation, which reduces the running time of the algorithm. Makespan may be only minimally impacted. This was the case in the experiments.

Presented are systems and methods for processing a graph representing the geometry of a building (e.g., a warehouse) or another delimited space and including nodes where the robot can turn or perform an action (e.g. at an aisle entry, at a workstation, etc.) and including an edge between two of those nodes when it is possible to travel in straight line between those two nodes without colliding into any static obstacle (e.g. some shelves) to obtain a routing graph. The collection control module 220 may expand the nodes of the graph and add arcs between those nodes to model turning duration and constraint as explained above. The collection control module 220 may also, in some implementations, add some loop arcs at nodes where waiting is possible as explained above. The collection control module 220 may determine a set of short cut arcs between nodes on a same line in a geographical representation of the graph, as explains above. The collection control module 220 may also obtain for each new arc a linear distance and an angle of rotation. The present application is also applicable to elevators and other devices. In that case, included may be some arcs between two nodes (entry and exit) that are of fixed duration. It could represent also the robot taking some kind of in house train to change room. In that case also arc travel duration may be fixed.

The VP* algorithm is executed by the collection control module 220 to determine a shortest path for a robot without collision to moving obstacles (when one exists) in the routing graph, visiting a sequence of n via points where n is an integer greater than or equal to 1, each via-point being described by a node in the graph and/or a position, a duration at the via-point (the duration, possibly null, of the action to perform at the via point), and possibly additional information, such as, but not limited to, an orientation for arriving, a load when arriving, an orientation for leaving, a load when leaving, given a robot geometry and given a set of speed profiles for each arc. When a position in the space describes the via point and no graph node describes the via point, a node for describing the via point may be obtained by projecting the position to the closest node of the graph.

The collection control module 220 determines the space occupied by the robot at each/any instant t and performs collision checking to verify that the space occupied by the robot does not intersect/collide with any moving obstacle (e.g., another robot). The collection control module 220 updates the information of the collision checking with a set of robot positions and orientations to consider it as a moving obstacle at the next iteration. In various implementations, the collision checking may save a summary of the robot positions and orientation during intervals (e.g., 1 second), a bounding box containing the space occupied by the robot at any instant in that time interval.

The collection control module 220 executes the VP* algorithm and determines the routing graph as described above. For each arc, the collection control module 220 may determine a travel time for each speed profile of its set of speed profiles, or a subset of that set. If a minimum waiting time is imposed, the collection control module 220 may add an arc from each node to itself with travel time equals to minimum waiting duration and no distance and no angle. The collection control module may determine the position of the robot at each instant and using its dimensions to perform the collision checking. The collection control module 220 may integrate the orientation of the robot as a part of the algorithm's queue elements. The collection control module may perform the VP* algorithm using a heap score function for sorting the heap that is a weighted sum of a penalty depending of the number of remaining via-points to reach and a lower bound estimate of the duration of path visiting all the remaining via-point and respecting the constraint from that state.

The collection control module 220 executes the IPP algorithm and determines trajectories/paths for the navigating robots to perform a set of orders, each order being composed of one or more tasks, and each task including one or several actions to perform each at a specific location in the space. In various implementations, the list of actions of a task contains exactly two actions: picking up an object at a given location (e.g., a shelf or a workstation) and delivering it at another location (e.g., a shelf or a workstation). The collection control module 220 may reserve one or several locations for the order until for all the tasks of the order, the pick-up or deliveries are completed. In various implementations, a partial order of completing the orders may be defined due to precedence constraints between tasks or actions of different orders.

The collection control module 220 may determine a set of rules to define a first order of completing the orders and a second order of performing the tasks of an order, or receiving it as input. The collection control module 220 sorts the orders and the tasks of each order in their respective orders. The collection control module 220 allocates each order (and its respective tasks) to one navigating robot and to a workstation based on travel time lower bound estimates. The IPP includes priorities between where robots are dynamically defined through the planning process by setting task dynamic priorities based on orders' and tasks' initial priority order and resources' availability. The collection control module 220 determines, in dynamic task priority order, paths for each task using the VP* algorithm and reserves the physical locations for the robot assigned to that task, including in the set of via-points of the task a final path to a waiting place, which is used if the robot must wait before starting its next task.

In various implementations, the collection control module may add multiple parallel arcs in the graph representing different speed profiles. Those arcs can be obtained by the collection control module 220 in different ways, such as: by selecting from a set of predefined speed profiles (in this case the collection control module 220 may consider the speed profiles that results in at least δ seconds more than the fastest path, where δ is a predetermined value and is greater than zero); by selecting from a set of predefined additional times for the arcs (in this case the collection control module 220 may determine the speed profile, such as by adjusting acceleration, deceleration and max speed for an arc while still keeping the speed profile trapezoidal).

The collection control module 220 may schedule a navigating robot to wait at some or only a subset of nodes and for different minimum duration for each node. For collision checking, the collection control module 220 may reserve a larger space than the one presently occupied by the navigating robot.

The collection control module 220 may perform collision checking based on precomputed trajectories for each arc or some arcs of the routing graph. The collection control module 220 may determine for each arc the robot trajectory for each or some speed profiles. In the VP* algorithm, the position of the robot for a given arrival time at the origin (departure) node of the arc can be determined by shifting the precomputed positions of the navigating robot in time depending on arrival time at the origin (departure) node of the arc.

In various implementations, orders may not require any resource. For instance, when tasks are composed of a pick-up and a delivery action, orders may not need to be delivered to or picked up at a workstation. In various implementations when tasks include a pick-up and a delivery action, all pickups and drop offs types may be included, such as shelf-to-workstation, or workstation-to-shelf, or shelf-to-shelf, all the tasks of a given order being of the same type. In various implementations, an order may require and reserve more than one resource, for instance, requiring a different resource for each action or requiring two or more resources for one action.

In various implementations, the collection control module 220 may sort the orders based on a priority rule, such as FIFO. The tasks of an order may be sorted by the collection control module 220 according to a priority rule. In various implementations, the order for tasks and orders may be received via user input.

In various implementations, waiting locations may be omitted or the same waiting place may be used for more than one navigating robot. In this case, the waiting place may only be reserved by the collection control module when a robot is there, and the robots may be given different starting positions.

In various implementations, the assignment of the tasks to the robot can be received via user input.

In the VP* algorithm, a queue element has several attributes (e.g. a node in the graph, an angular position at that node, a via-point index, a heap score). When determining if an element has already been added to the queue, the collection control module 220 could check, instead of equality of all the elements if an element has already been added, that is close enough in terms of one or several of the attributes (e.g. time and angular position), all other elements being equal. When determining if an element has already been added to the queue, the collection control module 220 could check, instead of equality of all the elements if an element has already been added to the queue, that is in the same given discrete interval for one or several of the attributes (e.g. for time and or angular position), all other elements being equal. In various implementations, attributes must be close enough in terms of value, some must belong to the same intervals, some must be equal.

The collection control module 220 may impose the secondary criterion for equality checking in the queue in VP* algorithm. When an element is equivalent to a previously added element of the queue, a secondary criterion could be used to define if it can nonetheless be added to the queue. In that case, the element is added based on a condition on one or several other criteria. For example, the element may be added by the collection control module 220 if its total distance (to the node of the queue element) is lower than that of the previously added element. In this example, the second criterion is minimum distance. Other possible criteria include minimum energy consumption and minimum time in movement. A criterion may be considered secondary if you say that a solution S1 is better than a solution S2 if S1 is better on the primary (main) criterion and if S1 and S2 are equally good on the primary criterion and S1 is better than S2 on the secondary criterion.

In various implementations, the collection control module 220 may determine the heap score based on additional criteria such as distance from origin. In this case, the collection control module 220 may determine the heap score as a weighted sum of penalty, estimated duration to destination, and the additional criteria.

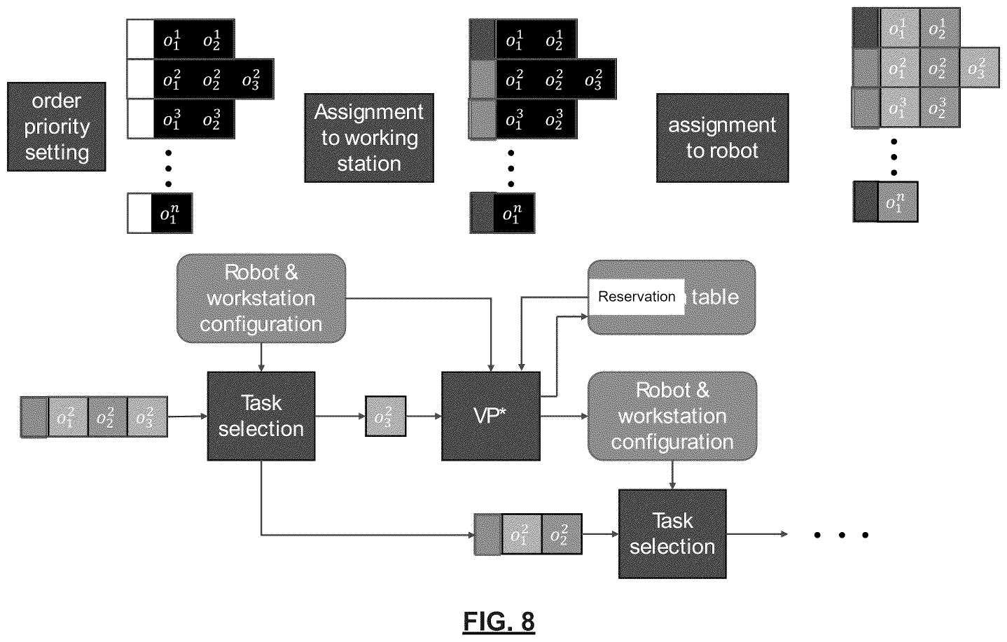

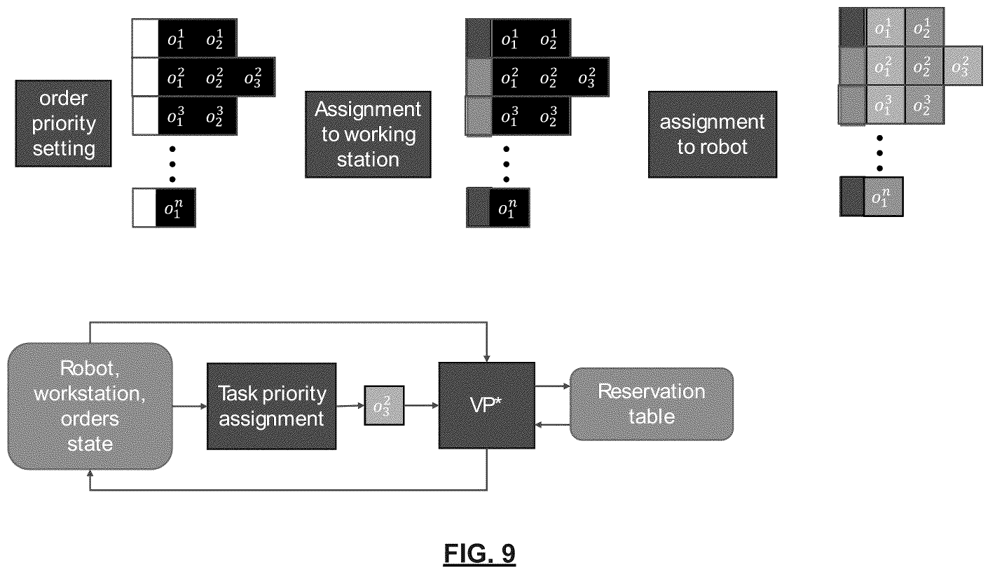

FIGS. 8 and 9 illustrate operation of the IPP algorithm. First, order priority is performed. The collection control module 220 may iterate the order to assign the current order to a working station and assign the task of this current order to the robots. Then (when assignment is complete), the collection control module 220 may iterate on the orders to define an priority order on the tasks of the current order and use VP* algorithm to determine paths that avoid collision (using and then updating the reservation table in the process).

In FIGS. 8 and 9, input is a set of orders. Each order contains a set of tasks. Generally speaking, certain orders may be done before some others based on order priority or precedence constraint. First, the collection control module 220 may sort the orders so that these preferences and constraints (if any) are satisfied. In FIG. 8, the orders are arranged to rows by their sorted position. For example, the first order o¹ including tasks o₁^{l} and o₂¹ is on the first row.

Before path planning, the collection control module 220 assigns resources (e.g., workstations, waiting locations, etc.) are assigned to orders. In FIG. 8, this is illustrated as the color of the first column—originally there is no color thus no assignment, but after assignment some are assigned to a blue workstation and some to an orange workstation.

Once the resources are allocated to orders, the collection control module allocates the robots to the tasks. In FIG. 8, there are three robots, a cyan robot, a green robot, and a purple robot. Different tasks of an order can be allocated to different robots, and a robot can be allocated to tasks of different orders.

Planning the robot paths may be performed by the collection control module 220 order by order, one task at a time. The collection control module 220 selects the task to be planned next based on the current status of robots and resources. Once the choice is made, the VP* algorithm plans a collision-free path or a task based on the starting configuration and the reservation/collision table that contains information about previously planned paths for all the robots. After planning the path, the collection control module 220 updates the reservation table and a new status for workstations and robots is present, so the collection control module 220 can proceed to choose a next task (if any). FIG. 9 is similar to FIG. 8, but illustrates the loop instead of the ellipsis of FIG. 8.

Regarding priority or precedence constraints, certain things are required to be done before other things. Naturally such requirements cannot be circular. More formally, precedence constraints between items (orders, tasks of the order, actions between tasks, etc.) can be defined by a strict partial order within a set of items, i.e., a binary relation<on a set S, such that for all a, b, c in S:
not a<a
if a<b, then not b<a
if a<b and b<c, then a<c.

Regarding sorting the items according to the precedence constraints, the collection control module 220 determines an order that is complete and compatible with a partial order induced by the precedence constraints. More formally, we find a binary relation <* on P such that for all a and b in S:
not a<* a
if a #b, then a<* b or b<* a but not both,
if a<b, then a<* b.

Precedence constraints may be required to be feasible, such as no blocking of any other navigating robots (e.g., when represented as a directed graph, there is no cycle in that graph).

FIG. 7 includes an illustration regarding an implementation of collision checking.

FIG. 10 illustrates the graph conversion. In FIG. 10, the shelves are provided to illustrate where the nodes of the warehouse graph come from and may not be part of the routing graph. The input to the algorithm is a graph layout (a warehouse graph) that contains nodes and their positions and undirected edges between neighboring nodes. To make path finding efficient even when the actual robot dynamics are taken into account, the warehouse graph may first be transformed/converted to a routing graph. In this transformation, each original node in the warehouse graph is replaced by several new nodes in the routing graph that are in the same position than the original nodes. The new nodes are connected by directed arcs to model turns and movements between nodes that lie on the same straight line. This transformation creates a directed multi-graph in which there can be several arcs from one node to another (instead of one as in the warehouse graph). In various implementations, travelling an arc takes a certain time that can be determined by the collection control module 220 using the robot dynamics. This determination of arc travel times can be made by the collection control module 220 before planning any of the paths, so the collection control module 220 can use algorithmic approaches that are based on finding paths in weighted graphs.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

1. An automated system for a space, comprising:
k navigating robots operating within the space to perform a set of orders, where k is an integer greater than or equal to two, where the space includes one or more waiting areas where any navigating robot may wait without blocking movement of any other navigating robot; and
a control module configured to receive the set of orders and communicate, to the k navigating robots, paths p for the k navigating robots to fulfil the set of orders, with each order in the set of orders (I) including one or more tasks including a sequence of actions to be performed at a location in the space, (II) having an order availability time after which any task of an order may start, and (III) being associated with a set of precedence constraints arising from at least one of (i) a relationship between orders and (ii) a resource of an order;
wherein movements communicated by the control module to the k navigating robots are determined for each order in the set of orders by:
(A) sorting the set of orders as function of the set of precedence constraints;
(B) assigning resources to complete each task of each order in the set of orders following the sequence of actions associated with the corresponding task;
(C) sorting the set of tasks of each order in the set of orders;
(D) assigning one of the k navigating robots to each task of each order in the set of orders;
(E) for each task t of each order in the set of orders and its assigned navigating robot r, while respecting the order of the sorted orders and the sorted tasks:
(i) computing an earliest start time for that task t based on the task t and the location of the navigating robot r in the space;
(ii) if the earliest start time of the task t is greater than the completion time of the last action performed by that navigating robot r: (1) finding and reserving a path for the navigating robot r to move to one of the waiting areas, (2) computing a waiting time for the navigating robot r to wait at the waiting area to start the task t while respecting the order availability time and the precedence constraints, and (3) assigning the navigating robot r a waiting time greater than or equal to the waiting time;
(iii) while accounting for previous reserved paths, determining a path p starting from the navigating robot r's current location, continuing along the path p to a sequence of locations associated with the task t's sequence of actions, and finishing the path p at the navigating robot r's (a) waiting area or (b) a last location of the last action in the sequence of actions, where waiting times associated with the path p accounting for the navigating robot r's travel time and action performance time; and
(iv) reserving the determined path p for performing task t associated with its corresponding order.

2. The automated system of claim 1 wherein the k navigating robots are configured to move along respective ones of the paths p assigned to those ones of the k navigating robots.

3. The automated system of claim 1 wherein the precedence constraint is defined by one or more actions of the first order being finished at least a predetermined period of zero or more seconds before the one or more actions of the second order can start.

4. (canceled)

5. (canceled)

6. (canceled)

7. (canceled)

8. The automated system of claim 1 wherein the control module is configured to assign a resource to an action of an order, the resource including one or more of a robot and a workstation.

9. The automated system of claim 1 wherein the control module is further configured to reserve a path p between a starting location of one of the navigating robots r and the waiting area of the navigating robot r.

10. The automated system of claim 1 wherein the control module is configured to determine the path p such that the navigating robot r performs the corresponding action for a time at least equal to the action's duration without the navigating robot r colliding with reserved paths of other ones of the navigating robots.

11. (canceled)

12. (canceled)

13. The automated system of claim 1 wherein the control module is configured to determine the earliest start time of the task k based on (a) completion times of tasks with paths reserved, (b) the task t's corresponding order start time, and (c) the set of precedence constraints.

14. The automated system of claim 1 wherein the control module is configured to determine a path p for the navigating robot r to one of the waiting areas based on previous reserved paths of other robots.

15. (canceled)

16. The automated system of claim 1 wherein the control module is configured to assign one waiting area to multiple ones of the k navigating robots.

17. The automated system of claim 1 wherein a total number of the one or more waiting areas is one of greater than k and less than k.

18. The automated system of claim 1 wherein a resource can be used by a predetermined maximum number of actions at a given time and a next action of the resource can start no earlier than the minimum end time of an action using the resource.

19. The automated system of claim 1 wherein the control module is further configured to reserve one or more paths for one or more moving obstacles.

20. The automated system of claim 1 where the control module is configured to:
receive a first graph representing a geometry of the space;
determine a second graph using the first graph; and
determine the paths for the k navigating robots in the second graph.

21. (canceled)

22. (canceled)

23. (canceled)

24. (canceled)

25. The automated system of claim 20 wherein the control module is configured to determine the paths based on the second graph and dynamics of the k navigating robots.

26. (canceled)

27. (canceled)

28. (canceled)

29. (canceled)

30. (canceled)

31. The automated system of claim 1 wherein the control module is configured to determine the paths of the navigating robots further based on the navigating robots not coming within a predetermined distance of any of the other ones of the k navigating robots while traveling along their respective paths.

32. The automated system of claim 1 wherein the control module is configured to determine the paths of the k navigating robots further based on constructing incrementally partial paths adding elements at the end of previously computed paths.

33. The automated system of claim 32 wherein the control module is configured to determine the paths based on comparisons of the partial paths.

34. The automated system of claim 33 wherein the control module is configured to compare the partial paths further based on heap scores of partial paths using a heap score function including a weighted sum of a penalty.

35. The automated system of claim 34 wherein the heap score function further includes a weighted sum of a lower bound of durations of a shortest path from the partial path's end to destination passing by all the unreached locations of the sequence of locations and staying at each location for at least the waiting time.

36. The automated system of claim 34 wherein the penalty is based on a number of remaining unreached locations of the sequence of locations and staying at each location for at least the minimum required time.

37. The automated system of claim 34 where the penalty is based on preventing collisions between ones of the k navigating robots.

38. The automated system of claim 37 wherein the preventing collisions is based on at least one of (a) dynamics of the k navigating robots and (b) geometry of the k navigating robots.

39. The automated system of claim 33 wherein the control module is configured to compare ones of the partial paths based on one or more criteria values for the partial paths, the criteria being sorted in a hierarchical order.

40. The automated system of claim 39 wherein the control module is further configured to compare criterion values of one or more of the criteria based on at least one of (a) criterion values being within the same predetermined value interval and (b) criterion values' difference being below a threshold.

41. The automated system of claim 40 wherein a first one of the criteria in the hierarchical order is earliest finishing time.

42. The automated system of claim 40 wherein the criteria include at least two secondary criteria, and a one of the second criteria in the hierarchical order is minimum time in movement.

43. The automated system of claim 1 wherein the space is one of a physical space and a virtual space.

44. The automated system of claim 1 wherein the control module is configured to:
reserve, in a reservation table, one or more of locations and areas in the space at one or more of times and periods for the previously planned paths of other ones of the k navigating robots; and
determine a feasible path for robot r at E.iii based on avoiding the one or more locations and areas at the one or more times and periods.

45. (canceled)

46. (canceled)

47. (canceled)

48. (canceled)

49. (canceled)

50. (canceled)

51. (canceled)

52. (canceled)

53. (canceled)

54. An automated method for a space, comprising:
by k navigating robots, operating within the space to perform a set of orders, where k is an integer greater than or equal to two, where the space includes one or more waiting areas where any navigating robot may wait without blocking movement of any other navigating robot;
receiving the set of orders and communicating, to the k navigating robots, paths p for the k navigating robots to fulfil the set of orders, with each order in the set of orders (I) including one or more tasks including a sequence of actions to be performed at a location in the space, (II) having an order availability time after which any task of an order may start, and (III) being associated with a set of precedence constraints arising from at least one of (i) a relationship between orders and (ii) a resource of an order;
wherein movements communicated to the k navigating robots are determined for each order in the set of orders by:
(A) sorting the set of orders as function of the set of precedence constraints;
(B) assigning resources to complete each task of each order in the set of orders following the sequence of actions associated with the corresponding task;
(C) sorting the set of tasks of each order in the set of orders;
(D) assigning one of the k navigating robots to each task of each order in the set of orders;
(E) for each task t of each order in the set of orders and its assigned navigating robot r, while respecting the order of the sorted orders and the sorted tasks:
(i) computing an earliest start time for that task t based on the task t and the location of the navigating robot r in the space;
(ii) if the earliest start time of the task t is greater than the completion time of the last action performed by that navigating robot r: (1) finding and reserving a path for the navigating robot r to move to one of the waiting areas, (2) computing a waiting time for the navigating robot r to wait at the waiting area to start the task t while respecting the order availability time and the precedence constraints, and (3) assigning the navigating robot r a waiting time greater than or equal to the waiting time;
(iii) while accounting for previous reserved paths, determining a path p starting from the navigating robot r's current location, continuing along the path p to a sequence of locations associated with the task t's sequence of actions, and finishing the path p at the navigating robot r's (a) waiting area or (b) a last location of the last action in the sequence of actions, where waiting times associated with the path p accounting for the navigating robot r's travel time and action performance time; and
(iv) reserving the determined path p for performing task t associated with its corresponding order.

55. An automated system for a space, comprising:
k navigating means operating within the space to perform a set of orders, where k is an integer greater than or equal to two, where the space includes one or more waiting areas where any navigating means may wait without blocking movement of any other navigating means;
means for receiving the set of orders and communicating, to the k navigating robots, paths p for the k navigating means to fulfil the set of orders, with each order in the set of orders (I) including one or more tasks including a sequence of actions to be performed at a location in the space, (II) having an order availability time after which any task of an order may start, and (III) being associated with a set of precedence constraints arising from at least one of (i) a relationship between orders and (ii) a resource of an order;
wherein movements communicated to the k navigating means are determined for each order in the set of orders by:
(A) sorting the set of orders as function of the set of precedence constraints;
(B) assigning resources to complete each task of each order in the set of orders following the sequence of actions associated with the corresponding task;
(C) sorting the set of tasks of each order in the set of orders;
(D) assigning one of the k navigating means to each task of each order in the set of orders;
(E) for each task t of each order in the set of orders and its assigned navigating means r, while respecting the order of the sorted orders and the sorted tasks:
(i) computing an earliest start time for that task t based on the task t and the location of the navigating means r in the space;
(ii) if the earliest start time of the task t is greater than the completion time of the last action performed by that navigating means r: (1) finding and reserving a path for the navigating means r to move to one of the waiting areas, (2) computing a waiting time for the navigating means r to wait at the waiting area to start the task t while respecting the order availability time and the precedence constraints, and (3) assigning the navigating means r a waiting time greater than or equal to the waiting time;
(iii) while accounting for previous reserved paths, determining a path p starting from the navigating means r's current location, continuing along the path p to a sequence of locations associated with the task t's sequence of actions, and finishing the path p at the navigating means r's (a) waiting area or (b) a last location of the last action in the sequence of actions, where waiting times associated with the path p accounting for the navigating means r's travel time and action performance time; and
(iv) reserving the determined path p for performing task t associated with its corresponding order.
